(19) United States
(12) Patent Application Publication
(10) Pub. No.: US 2005/0075971 A1
(43) Pub. Date: Apr. 7, 2005

(54) Method and system for charitable lending through retirement

(76) Inventor: Douglas S. Delaney, Bluffton, SC (US)

Correspondence Address: WELSH & FLAXMAN LLC, 2450 CRYSTAL DRIVE, SUITE 112, ARLINGTON, VA, 22202, US

(21) Appl. No.: 10/952,924

(22) Filed: Sep. 30, 2004

Related U.S. Application Data
(60) Provisional application No. 60/507,521, filed on Oct. 2, 2003.

(51) Int. Cl. G06F 17/60

(52) U.S. Cl. 705/38

(57) ABSTRACT

A method for implementing charitable lending through a retirement plan, which can be implemented via a computer system having the following steps: (a) creating or using a self directed plan of a donor with a designated plan custodian; (b) loaning funds from a self directed plan to a tax-exempt organization; (c) creating a promissory note in the amount of the loaned funds payable to the plan custodian for the benefit of the donor; (d) requiring the tax-exempt organization use a portion of the loaned funds to purchase a life insurance policy on the donor, (e) enabling the tax-exempt organization to retain the balance of the loaned funds for their charitable purpose; (f) requiring loan payments by the tax-exempt organization to the plan custodian during the donor's lifetime; and upon the death of the donor, the tax-exempt organization receives the net death benefit proceeds from the life insurance policy, the net death benefit proceeds being the insurance policy payoff amount minus the loan repayment amount.

### BACKGROUND OF THE INVENTION

1. Field of the Invention

The invention relates to a method and system for charitable lending through the use of retirement plans wherein a donor can provide an immediate cash benefit to their favorite charity in the form of a loan which does not create a taxable event and the loan is secured by an insurance policy. In particular, the invention relates to a method and system for no risk charitable lending through retirement plans.

2. Description of the Prior Art

Traditional gifting from funds derived from retirement plans requires a withdrawal from the plan and an immediate triggering of income tax to the donor of the gift. This tax trap magnifies the loss of family wealth and increases the cost of the gift. It is known to those skilled in the art that deferred gifting is possible by changing the beneficiary designation of a qualified plan. However, this planning does not generate any immediate income to the charity.

As such, charities and donors have been left without an alternative for the utilization of significant assets. The present invention overcomes these problems by providing a useful and effective mechanism for estate planning.

### SUMMARY OF THE INVENTION

It is, therefore, an object of the present invention to provide a method for implementing charitable lending through a retirement plan, which can be implemented via a computer system having the following steps: (a) creating or using a self directed plan of a donor with a designated plan custodian; (b) loaning funds from a self directed plan to a tax-exempt organization; (c) creating a promissory note in the amount of the loaned funds payable to the plan custodian for the benefit of the donor; (d) requiring the tax-exempt organization use a portion of the loaned funds to purchase a life insurance policy on the donor, (e) enabling the tax-exempt organization to retain the balance of the loaned funds for their charitable purpose; (f) requiring loan payments by the tax-exempt organization to the plan custodian during the donor's lifetime; and upon the death of the donor, the tax-exempt organization receives the net death benefit proceeds from the life insurance policy, the net death benefit proceeds being the insurance policy payoff amount minus the loan repayment amount.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIGS. 1-8 show a schematic overview of the Charitable IRA of the present invention.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as the basis for the claims and as a basis for teaching one skilled in the art how to make and/or use the invention.

A method and system for charitable lending using a self directed retirement plan is described herein. Self directed meaning any plan in which the owner is permitted to direct the funds into a desired investment vehicle and the custodian does not assume a fiduciary duty. The present disclosure describes the present retirement plan as it relates to treatment under current federal tax law. The present charitable lending plan is supported by substantial legal authority as that term is defined in Internal Revenue Code Section (“IRC §”) 6662 and Treasury Regulations issued pursuant thereto by the Treasury Department.

The present charitable lending system provides an opportunity allowing an individual, free of charge or income tax, to guarantee the principal value of an IRA (or a portion thereof), while simultaneously providing a substantial and immediate cash benefit to their favorite charity. The term IRA is contemplated to include all retirement plans including any plan, account or trust created under Tide 26 of the United States Code (Income Tax Code), including but not limited to those in Subchapter D and F, in particular trust formed under Subtitle A, Chapter 1 of Tide 26 Internal Revenue Code Sections 401, 408 or 408A. An IRA custodian is contemplated to include any entity, trustee, custodian or qualified party qualified to administer any retirement plan, account or trust created under Subtitle A, Chapter 1 of Tide 26 of the United States Code (Income Tax Code), including but not limited to those in Subchapter D and F, in particular, those as defined in Section 408(a)(2) of the Internal Revenue Code.

The present charitable lending plan involves a loan from the individual to their favorite charity. The loan derives from inside an individual's retirement plan, however, throughout the specification the term IRA is used, as this is a retirement plan available and understood by most individuals. The loan is in many respects similar to a bond investment. The difference being that, instead of lending to a business, the IRA owner is lending to a charity. The loan provides fair market interest. The loan principal is fully secured with repayment guaranteed by an insurance policy purchased by the charity with the funds provided through the loan.

For example, if the lender loans $100,000 to a charity, the charity uses $50,000 to make a single premium payment on an insurance policy on the lender's life providing a death benefit of $100,000. The death benefit is collaterally assigned to the lender. Because the insurance premium is substantially less than the death benefit used to repay the loan, the charity receives an immediate infusion of $50,000 in charitable cash.

As will be discussed below in greater detail, the present loan is an arm's length, interest only secured loan bearing fair market interest. The principal amount of the loan becomes due upon the death of the lender. Interest payments are made on an annual basis. As such, there are no “disqualified persons” as defined by the IRC, so there is no prohibited transaction that would generate a taxable distribution. The terms of the note are fair to the IRA, so there is no self-dealing. The benefit to the charity is ancillary to the arm's length nature of the loan. The receipt of interest is not unrelated business taxable income. The repayment of the loan is tax-free. Upon the individual's date of death, the IRA is transferred to beneficiaries, as it normally would be.

### Transactional Overview

In accordance with a first embodiment of the present invention, the present charitable lending plan involves several different and independent transactions. Each transaction has economic substance in and of its own right. While there are tax benefits, the transactions involved are motivated by business reasons, including investment diversification and security. As those skilled in the art will appreciate, the present charitable lending plan via retirement plans may be implemented by way of various computer systems or by traditional analysis techniques. In accordance with a preferred embodiment of the present invention, the present plan is implemented using a computer system programmed with software designed to implement the present plan.

In general, and in accordance with a first embodiment, the charitable lending plan involves the following transactions:
An existing Individual Retirement Account (Old IRA) is transferred trustee to trustee to a newly formed self-directed IRA or a qualified existing self-directed plan is identified (New IRA).
The funds in the New IRA are directed to a newly formed, wholly owned, limited liability company (LLC). The Manager of the LLC (Manager) is the IRA owner. The entirety of the ownership of the LLC is titled for the benefit of the IRA owner in the New IRA. All distributions from the LLC are directed to the institutional custodian of the New IRA. The custodians could be various commercial entities, such as Pensco or insurance companies.
A portion of the funds in the LLC are loaned (Loan) with adequate security and bearing fair interest to a tax-exempt organization (Charity) selected in the discretion of the Manager of the LLC. Neither the Manager nor the IRA owner is a board member or officer of the Charity. The Charity is not a private foundation as that term is set forth in the IRC. The loan is an interest only balloon note with a varying term and no pre-payment penalty. The secured interest is properly recorded.
The Charity utilizes a portion of the loaned funds to purchase a life insurance policy on the IRA owner (Policy). The death benefits provided by the Policy serve as the source of collateral securing the Loan. The charity pays a premium on the life insurance policy, which is calculated by the insurance company depending on what type of policy and age and health of IRA owner. The Charity is the owner and irrevocable beneficiary of the Policy. The IRA owner signs the Policy application as insured. The Charity, in their board's discretion, utilizes the balance of the Loan funds (in excess of the insurance premium) for their charitable purposes.
The Charity makes Loan payments of interest and/or principal during the lifetime of the IRA owner. The IRA owner may independently donate funds to the Charity during their lifetime to offset the Loan payments and these donated funds may be utilized to make payments on the Loan.
Upon the death of the IRA owner, the Charity receives the proceeds from the Policy. The death benefits are received by the Charity income tax free under IRC § 101. The proceeds from the Policy are utilized by the Charity to pay the Loan and any accrued interest to the LLC. The beneficiary of the New IRA is determined in accordance with the beneficiary designation on file with the IRA custodian. Taxation of distributions from the New IRA to the IRA owner or their beneficiaries is in accordance with the IRC.

The substantial legal authority supporting this lending plan, discussed in greater detail below, is derived from separate independent sources of legal authority. In an effort to be concise, we do not explicitly address those general areas of tax treatment. For example, tax-free rollovers, codified in IRC § 408(d)(3), have been in common practice for in excess of a decade. Where the terms of the trustee-to-trustee transfer are satisfied and the custodian of the New IRA is an approved custodian, the tax-free nature of the transfer will generally be respected. In addition, the formation and capital contribution to a newly formed LLC is tax free under IRC § 721.

The special characteristics of the transactions set forth herein and their interaction warrant detailed discussion. After a brief introduction, the following issues related to the present charitable lending through a retirement plan are addressed:
(1) Prohibited Transactions,
(2) Prohibited Pledging of Assets,
(3) Prohibited Investment in Insurance,
(4) Unrelated Business Taxable Income,
(5) Exclusive Benefit Rule,
(6) Deemed Distribution by Gift,
(7) Insurable Interest,
(8) Quid Pro Quo,
(9) Economic Substance Doctrine, and
(10) Security Issuance.

### Introduction to Underlying Legal Authority for the Present Plan

Individual Retirement Accounts or “IRAs,” governed by IRC Section 408, are entitled to own various assets subject to certain restrictions. This broad investment selection was made clear in Field Service Advisory 200128011 (Apr. 6, 2001) wherein the Internal Revenue Service (IRS) considered the ability of an IRA Owner to invest in a Foreign Sales Corporation (FSC).

There is no specific Code provision or regulation prohibiting an IRA from owning the stock of a FSC. The type of investment that may be held in an IRA is limited only with respect to insurance contracts, under section 408(a)(3), and with respect to certain collectibles, under section 408(m)(1).

Consistently, Private Letter Ruling 8241079 reflected a ruling concluding in favor of an unregistered bond. The equity or debt-based investment in a closely held entity, such as the LLC, is permitted. While it is conclusive that an IRA could own an LLC interest or a promissory note, this is only the first step of the legal analysis.

Subsection (e) of IRC Section 408 provides a concise statement of law from which to begin our analysis of some additional matters to be considered in order to conclude in favor of the continued tax-deferred environment of the IRA. IRC 408(e)(1) provides:
[An] individual retirement account is exempt from taxation . . . unless such account has ceased to be an individual retirement account by reason of paragraph (2) or (3).

Notwithstanding the preceding sentence, any such account is subject to the taxes imposed by Section 511 (relating to imposition of tax on unrelated business taxable income of charitable, etc., organizations).

Simply, the IRA is tax exempt with certain exceptions. The references to IRC § 408(e)(2) and (3) are to, respectively, Prohibited Transactions and Improper Borrowing. A cousin of Improper Borrowing, Prohibited Pledging of Assets (see IRC 408(e)(4)) is, along with Prohibited Transactions, dealt with specifically below. Section 511 is otherwise known as Unrelated Business Taxable Income (“UBTI”). While the other restrictions set forth in this correspondence cause a deemed distribution (and therefore, taxable income) from the IRA, UBTI subjects only certain income to taxation. Because it is probably the most misunderstood and overly dramatized code section, Prohibited Transactions provides an excellent starting point from which to commence our analysis.

### Prohibited Transactions

A proper review of the law concerning prohibited transactions as it applies to the present plan should involve an analysis of both the Internal Revenue Code (IRC) and the Employee Retirement Income Security Act of 1974 (ERISA), as both are applicable.

Internal Revenue Code

The prohibited transaction exclusion, set forth in IRC § 408(e)(2), expressly incorporates the laundry list of transactions provided in IRC § 4975(c)(1). IRC § 4975(c)(1) provides that a “prohibited transaction” includes any “direct or indirect”:
(A) sale or exchange, or leasing, of any property between a plan and a disqualified person;
(B) lending of money or other extension of credit between a plan and a disqualified person;
(C) furnishing of goods, services, or facilities between a plan and a disqualified person;
(D) transfer to, or use by or for the benefit of, a disqualified person of the income or assets of a plan;
(E) act by a disqualified person who is a fiduciary whereby he deals with the income or assets of a plan in his own interest or for his own account; or
(F) receipt of any consideration for his own personal account by any disqualified person who is a fiduciary from any party dealing with the plan in connection with a transaction involving the income or assets of the plan.

Because it does not involve a “disqualified person,” the retirement plan does not trigger a prohibited transaction. This term, defined in IRC 4975(e)(2), generally includes fiduciaries, employers, employees, family members and entities in which equity interests in excess of fifty (50%) percent are owned by the IRA owner (or family members).

In Private Letter Ruling 8241079, a similar fact pattern as that presented by the present plan did not result in a prohibited transaction. This ruling concluded that
The [Charity] is not related to the self-directed IRA in such a way as to come within the definition of a disqualified person as described in section 4975(e)(2)(A)-(I); it is simply a detached and unrelated organization . . . .

The clear applicability of Private Letter Ruling 8241079 to the present retirement plan is overwhelming. However, although indicative of administrative consistency, evidencing substantial legal authority and directly related to an increased hazard of litigation, this ruling is binding only with respect to the taxpayer to whom it is issued. Therefore, each statutory category is reviewed below in the context of the present plan to arrive at an independent conclusion that there is no disqualified person present to trigger a prohibited transaction.

Fiduciary

In accordance with the present plan, the IRA Owner will, through the participation of the custodian, be the sole member of the LLC and be appointed as the Manager of the LLC. After initial formation and capitalization of the LLC, the IRA Owner will likely be a “fiduciary” as a result of the Manager's role in directing the investments of the LLC. Thus, after initial formation and capitalization of the LLC, IRC § 4975(e)(2)(A) provides that the IRA Owner will likely be a “disqualified person.” However, the issue in this case, is whether the IRA Owner is a disqualified person prior to formation or capitalization of the LLC.

Prior to the formation and capitalization, the LLC is not in existence. The LLC has no members or membership interests. The LLC has no equity interests outstanding. Before its legal formation, the LLC does not fit within the definition of a “disqualified person” under § 4975(e)(2). Thus, the initial capital contribution to the LLC is not a prohibited transaction. This specific issue was addressed in Swanson v. Commissioner, 106 T.C. 76 (1996). The Tax Court, in holding for the Taxpayer, Worldwide, provided the following:
We find that it was unreasonable for [the IRS] to maintain that a prohibited transaction occurred when Worldwide's stock was acquired by IRA #1. The stock acquired in that transaction was newly issued—prior to that point in time, Worldwide had no shares or shareholders. A corporation without shares or shareholders does not fit within the definition of a disqualified person under section 4975(e)(2)(G). It was only after Worldwide issued its stock to IRA #1 that petitioner held a beneficial interest in Worldwide's stock, thereby causing Worldwide to become a disqualified person under section 4975(e)(2)(G).
Therefore, [the IRS'] litigation position with respect to this issue was unreasonable as a matter of both law and fact.

The choice of entity (LLC) does not affect the holding. It is the nature of the newly issued equity interest. The IRS is cognizant of the hazards of litigation presented by pursuing this course as a mode of challenge. The Tax Court in holding their position “unreasonable” resulted in the awarding of litigation costs to the taxpayer. In conclusion, the direction of funds as an initial capitalization from the New IRA to the LLC does not involve a disqualified person.

This conclusion was also acknowledged by the IRS in Field Service Advisory (FSA) 200128011 (Apr. 6, 2001). In that FSA, the Service provided
In light of Swanson, we conclude that a prohibited transaction did not occur under section 4975(c)(1)(A) in the original issuance of the stock of FSC A to the IRAs in this case. Similarly, we conclude that payment of dividends by FSC A to the IRAs in this case is not a prohibited transaction under section 4975(c)(1)(D). We further conclude, considering Swanson, that we should not maintain that the ownership of FSC A stock by the IRAs, together with the payment of dividends by FSC A to the IRAs, constitutes a prohibited transaction under section 4975(c)(1)(E).

Even conceding the conclusion that the LLC Manager and IRA Owner is a fiduciary after the formation of the LLC, the retirement plan does not envision any transaction between the Manager or LLC and the plan. Therefore, while the disqualified person would be present, the necessary transaction would not.

Employer/Employee

Upon implementation, the IRA involves neither an employer nor employee. The Swanson case, in footnote 14, provides guidance in this analysis as well to arrive at the same conclusion. Specifically, the court stated:
14/ Furthermore, we find that at the time of the stock issuance, Worldwide was not, within the meaning of sec. 4975(e)(2)(C), an “employer”, any of whose employees were beneficiaries of IRA #1. Although sec. 4975 does not define the term “employer”, we find guidance in sec. 3(5) of the Employee Retirement Income Security Act of 1974 (ERISA), Pub. L. 93-406, 88 Stat. 829, 834. In pertinent part, ERISA sec. 3(5) provides that, for plans such as an IRA, an “‘employer’ means any person acting directly as an employer, or indirectly in the interest of an employer, in relation to an employee benefit plan * * *.” Because Worldwide did not maintain, sponsor, or directly contribute to IRA #1, we find that Worldwide was not acting as an “employer” in relation to an employee plan, and was not, therefore, a disqualified person under sec. 4975(e)(2)(C). As there is no evidence that Worldwide was an “employee organization”, any of whose members were participants in IRA #1, we also find that Worldwide was not a disqualified person under sec. 4975(e)(2)(D).
   Code Section 4975(e)(2) pertaining to employees/employers should be inapplicable on a plain reading of the statute.
   Family Member

Disqualified Person includes a “member of the family” as that term is defined in IRC 4975(e)(6). The family of an individual, or fiduciary, “shall include his spouse, ancestor, lineal descendant, and any spouse of a lineal descendant.” Id. Though not applicable, the more expansive attribution rules provided by IRC Sections 267 and 318 would not result in a determination of Disqualified Person.

The proper interpretation of a statute, addressed in Crane v. Commissioner, 331 U.S. 1 (1947), is a simple reading. The “words of statutes—including revenue acts—should be interpreted where possible in their ordinary, everyday senses.” Id. Code Section 4975(e)(6) is not applicable to the retirement plan under a plain, common sense interpretation. These code sections make absolutely no attempt to include, either directly, indirectly, or by example any other manner to include reference to any charitable organization.

Equity Interest in an Entity.

Section 4975(e)(2) encompasses equity interests in an entity in excess of fifty (50%) percent. By reference, the precluded ownership interests include, by attribution, the broad statutory reach of IRC 267(c)(4). Notwithstanding, neither the explicit language in the statute nor the attribution rules provide that the Charity would be considered a Disqualified Person. Further, there are no outstanding equity interests in the Charity. This, in its own right, precludes the existence of the asset expressly considered by the statute.

The failure to involve a disqualified person is determinative on the issue of whether there is a prohibited transaction under the IRC. It is noteworthy that, even under the more onerous self-dealing statues applicable to private foundations, the transactions contemplated by the retirement plan would not involve a disqualified person. IRC § 4946.

Employee Retirement Income Security Act of 1974 (ERISA)

Even though an IRA is not subject to ERISA, and thus is generally exempt from regulation by the Department of Labor (DOL), the DOL has the specific authority to issue exemptions from the application of the prohibited transaction rules. Enforcement of the IRA prohibited transaction rules are, however, exclusively within the jurisdiction of the Treasury. Notwithstanding, pursuant to Presidential Reorganization Plan No. 4 of 1978:
[T]he authority of the Secretary of the Treasury to issue interpretations regarding section 4975 of the Code, subject to certain exceptions . . . has been transferred to the Secretary of Labor and the Secretary of the Treasury is bound by such interpretations.
   In fashion similar to the IRC, the ERISA listing of prohibited transactions (set forth in 29 U.S.C. Section 1106) provides:

(a) Transactions between plan and party in interest

Except as provided in section 1108 of this title:
(1) A fiduciary with respect to a plan shall not cause the plan to engage in a transaction, if he knows or should know that such transaction constitutes a direct or indirect—
   (A) sale or exchange, or leasing, of any property between the plan and a party in interest;
   (B) lending of money or other extension of credit between the plan and a party in interest;
   (C) furnishing of goods, services, or facilities between the plan and a party in interest;
   (D) transfer to, or use by or for the benefit of a party in interest, of any assets of the plan; or
   (E) acquisition, on behalf of the plan, of any employer security or employer real property in violation of section 1107(a) of this title.

Where the IRC utilizes the term “disqualified person,” ERISA utilizes the term “party-in-interest.” 29 U.S.C. Section 1106. Subsections (14) and (15) of Section 1002 of Title 29 of the U.S. Code defines this term as follows:
(14) The term “party in interest” means, as to an employee benefit plan—(A) any fiduciary (including, but not limited to, any administrator, officer, trustee, or custodian), counsel, or employee of such employee benefit plan; (B) a person providing services to such plan; (C) an employer any of whose employees are covered by such plan; (D) an employee organization any of whose members are covered by such plan; (E) an owner, direct or indirect, of 50 percent or more of—(i) the combined voting power of all classes of stock entitled to vote or the total value of shares of all classes of stock of a corporation. (ii) the capital interest or the profits interest of a partnership, or (iii) the beneficial interest of a trust or unincorporated enterprise, which is an employer or an employee organization described in subparagraph (C) or (D); (F) a relative (as defined in paragraph (15)) of any individual described in subparagraph (A), (B), (C), or (E); (G) a corporation, partnership, or trust or estate of which (or in which) 50 percent or more of (i) the combined voting power of all classes of stock entitled to vote or the total value of shares of all classes of stock of such corporation, (ii) the capital interest or profits interest of such partnership, or (iii) the beneficial interest of such trust or estate, is owned directly or indirectly, or held by persons described in subparagraph (A), (B), (C), (D), or (E); (H) an employee, officer, director (or an individual having powers or responsibilities similar to those of officers or directors), or a 10 percent or more shareholder directly or indirectly, of a person described in subparagraph (B), (C), (D), (E), or (G), or of the employee benefit plan; or (I) a 10 percent or more (directly or indirectly in capital or profits) partner or joint venturer of a person described in subparagraph (B), (C), (D), (E), or (G). The Secretary, after consultation and coordination with the Secretary of the Treasury, may by regulation prescribe a percentage lower than 50 percent for subparagraph (E) and (G) and lower than 10 percent for subparagraph (H) or (I). The Secretary may prescribe regulations for determining the ownership (direct or indirect) of profits and beneficial interests, and the manner in which indirect stockholdings are taken into account. Any person who is a party in interest with respect to a plan to which a trust described in section 501 (c)(22) of title 26 is permitted to make payments under section 1403 of this title shall be treated as a party in interest with respect to such trust.
(15) The term “relative” means a spouse, ancestor, lineal descendant, or spouse of a lineal descendant.

As discussed in the Disqualified Person analysis set forth above, neither the IRA Owner nor LLC will have any capital or voting interest in the Charity. The Charity does not provide any services to the IRA Owner or LLC. In addition, the Charity is not deemed to be a relative of the IRA Owner or LLC. There is no “party in interest” as it relates to the lending transaction contemplated by the retirement plan.

Subsection (b) of 29 U.S.C. Section 1106, in addition to the party in interest prohibition, provides direct prohibition of transactions between the plan (or, in this case, the IRA) and the fiduciary (i.e., the IRA Owner).

(b) Transactions between plan and fiduciary

A fiduciary with respect to a plan shall not—
(1) deal with the assets of the plan in his own interest or for his own account,
(2) in his individual or in any other capacity act in any transaction involving the plan on behalf of a party (or represent a party) whose interests are adverse to the interests of the plan or the interests of its participants or beneficiaries, or
(3) receive any consideration for his own personal account from any party dealing with such plan in connection with a transaction involving the assets of the plan.

The role of the Manager and IRA Owner in the present retirement plan does not involve any of the prohibited transactions set forth above. A violation will not occur merely because the fiduciary derives some incidental benefit from a transaction involving IRA assets. DOL Advisory Opinion 2000-10A, Jul. 27, 2001. The IRA Owner, individually, does not receive any “consideration” for their own personal account as a result of the plan. This conclusion is supported by the DOL Advisory Opinions 2001-09A (Dec. 14, 2001) and 92-08A (Feb. 20, 1992).

Even under the most liberal reading of the relevant statutes provided in the IRC or ERISA, neither the LLC, upon formation, nor the Charity, at any time (provided the IRA Owner is not an officer, employee or board member) is considered a Disqualified Person or Party in Interest with respect to the IRA. The present retirement plan does not involve a prohibited transaction as that term is set forth under applicable law.

### Prohibited Pledging of Assets

IRC § Section 408(e)(4) provides

If, during any taxable year of the individual for whose benefit an individual retirement account is established, that individual uses the account or any portion thereof as security for a loan, the portion so used is treated as distributed to that individual.

This prohibition ensures that the present retirement plan participant cannot effectively consume the economic value of the IRA without reporting a taxable distribution. Whether utilizing the account as collateral for a home mortgage, to secure a margin account, or a direct loan, the borrowing of value or collateral from an IRA, by the retirement plan participant or a disqualified person, is considered a taxable distribution.

This prohibition does not, however, preclude the IRA Owner from directing the assets in the IRA into debt related investments. The IRA Owner is legally entitled to invest, within the IRA, in bonds, bond-related funds, promissory notes and other debt related investments whether in a publicly traded or private market. Debt related investments are commonly held by IRA owners.

In the present retirement plan, the IRA Owner, through the LLC, is in the private lending business. These are local debt related investments. The investments generate interest income from independent, non-Disqualified Persons. The LLC obtains adequate interest and security. The loaned funds are not utilized in a manner that benefits the IRA Owner, other than philanthropic satisfaction. The retirement plan does not involve a prohibited pledging of assets for the benefit of the IRA Owner. The funds transacted are merely another investment of the IRA.

### Prohibited Investment in Insurance

The laws concerning the allowable investments for an IRA are provided in the negative. That is, with exceptions for certain assets or certain types of income, all investments are allowed to be held by an IRA. This concept was made clear in the report of the Staff of the Joint Committee on Taxation, General Explanation of the Economic Recovery Act of 1981, at 212 (1981). See also, FSA 200128011.

One exception involves the purchase of life insurance. IRC § 408(a)(4) provides that “[n]o part of the trust funds will be invested in life insurance contracts.” As the present retirement plan expressly envisions the purchase of an insurance policy by the Charity, this code section warrants discussion.

On a plain reading of the statute, as required by the Supreme Court in Crane, it is noted that this section fails to apply, as it is the Charity investing in the Policy instead of the IRA. The Charity is the owner and beneficiary of the Policy. Risks and rewards of mortality are borne by the Charity, not the LLC or IRA owner. The Loan bears interest at the same rate regardless of the period outstanding. The Loan is independent of the investment return generated by the Policy. It would be a considerable interpretative stretch to include within the prohibition an asset owned by a wholly unrelated organization. Regardless of whether the asset serves as collateral, the term “trust funds” cannot reasonably include the equity ownership of assets owned by organization in which the IRA or the LLC holds no equity ownership. ERISA regulations currently support this conclusion.

Paragraph (a), Section 2510.3-101 of Title 29 the Code of Federal Regulations (“CFR”) concerning the ERISA laws sets forth the applicability of the section to various parts of ERISA and the IRC as it relates to what is considered a “plan asset,” or in this case, a portion of the trust fund. Specifically, it provides that this ERISA regulation is applicable to the interpretation of prohibited transactions under IRC § 4975.
(a) In general. (1) This section describes what constitutes assets of a plan with respect to a plan's investment in another entity for purposes of subtitle A, and parts 1 and 4 of subtitle B, of title I of the Act and section 4975 of the Internal Revenue Code.

Subparagraph (2), paragraph (b) of Section 2510.3-101 provides
(2) Generally, when a plan invests in another entity, the plan's assets include its investment, but do not, solely by reason of such investment, include any of the underlying assets of the entity. However, in the case of a plan's investment in an equity interest of an entity that is neither a publicly-offered security nor a security issued by an investment company registered under the Investment Company Act of 1940 its assets include both the equity interest and an undivided interest in each of the underlying assets of the entity, unless it is established that (i) the entity is an operating company, or (ii) equity participation in the entity by benefit plan investors is not significant.
Therefore, any person who exercises authority or control respecting the management or disposition of such underlying assets, and any person who provides investment advice with respect to such assets for a fee (direct or indirect), is a fiduciary of the investing plan.

Thus, this section would provide that the assets of the LLC (i.e., the promissory note) would certainly be included within the definition of plan assets or trust funds of the IRA. The IRA wholly owns the LLC. The LLC owns the requisite twenty-five (25%) percent interest necessary to arise to “significant” ownership. 29 CFR Section 2510.3-101(f). Further, the IRA Owner exercises complete authority and control over the disposition of the promissory note.

The prohibition of insurance ownership, however, would only be triggered if the Charity's ownership of the Policy could somehow be attributed to the LLC or the IRA. First, the Charity has no outstanding equity ownership. Second, the LLC does not have title to any equity ownership in the Charity. Third, the IRA does not have title to any equity ownership in the Charity. Fourth, the Manager of the LLC is not a board member or officer of the Charity. Fifth, the IRA owner is not a board member or officer of the Charity. Sixth, neither the IRA nor LLC possess any ownership interest in the Policy. Seventh, neither the IRA nor LLC have any ownership rights to borrow, surrender or otherwise affect the Policy. The Charity's ownership of the policy cannot be attributed, directly or indirectly, to the IRA or the LLC. Therefore, the prohibition of insurance ownership is not applicable.

Collateral does not arise to equity. Collateralized assets are not considered a portion of the plan assets or trustfund. This conclusion is made clear in the ERISA regulations including the example setting forth the proper treatment of a comparable mortgage based asset: Government Mortgage Pools. In 29 CFR Section 2510.3-101(i), the Regulations provide:
(i) Governmental mortgage pools. (1) Where a plan acquires a guaranteed governmental mortgage pool certificate, as defined in paragraph (i)(2), the plan's assets include the certificate and all of its rights with respect to such certificate under applicable law, but do not, solely by reason of the plan's holding of such certificate, include any of the mortgages underlying such certificate.

Other examples provided in this Federal Regulation provide excellent guidance on those circumstances wherein particular assets are attributed to another entity. These examples, set forth below, reflect that the attribution is contingent upon equity interest and management participation. Both of these requisite qualities are lacking in the retirement plan. The Policy is not considered a portion of the trust fund.
(j) Examples. (1) A plan, P, acquires debentures issued by a corporation, T, pursuant to a private offering. T is engaged primarily in investing and reinvesting in precious metals on behalf of its shareholders, all of which are benefit plan investors. By its terms, the debenture is convertible to common stock of T at P's option. At the time of P's acquisition of the debentures, the conversion feature is incidental to T's obligation to pay interest and principal. Although T is not an operating company, P's assets do not include an interest in the underlying assets of T because P has not acquired an equity interest in T. However, if P exercises its option to convert the debentures to common stock, it will have acquired an equity interest in T at that time and (assuming that the common stock is not a publicly-offered security and that there has been no change in the composition of the other equity investors in T) P's assets would then include an undivided interest in the underlying assets of T.

This example is favorably distinguishable (notwithstanding its positive result) as there is no option to purchase an equity interest in the Charity. There are no equity interests outstanding.
Example. (9) A plan, P, acquires a limited partnership interest in X pursuant to a private offering. There is significant equity participation in X by benefit plan investors. X is engaged in the business of making “convertible loans” which are structured as follows: X lends a specified percentage of the cost of acquiring real property to a borrower who provides the remaining capital needed to make the acquisition. This loan is secured by a mortgage on the property. Under the terms of the loan, X is entitled to receive a fixed rate of interest payable out of the initial cash flow from the property and is also entitled to that portion of any additional cash flow, which is equal to the percentage of the acquisition cost that is financed by its loan. Simultaneously with the making of the loan, the borrower also gives X an option to purchase an interest in the property for the original principal amount of the loan at the expiration of its initial term. X's percentage interest in the property, if it exercises this option, would be equal to the percentage of the acquisition cost of the property, which is financed by its loan. The parties to the transaction contemplate that the option ordinarily will be exercised at the expiration of the loan term if the property has appreciated in value. X and the borrower also agree that, if the option is exercised, they will form a limited partnership to hold the property. X negotiates loan terms, which give it rights to substantially influence, or to substantially participate in, the management of the property, which is acquired with the proceeds of the loan. These loan terms give X significantly greater rights to participate in the management of the property than it would obtain under a conventional mortgage loan.

Neither the IRA Owner nor the LLC have the right to substantially influence or to substantially participate in, the management of the Policy or benefit from any equity or mortality return from the Policy. The collateralization requirement of the Policy is commercially reasonable. The Policy is not attributed or otherwise considered as a portion of the trust fund of the IRA.

### Unrelated Business Taxable Income

As previously provided above, IRC § 408(e)(1) states:
[An] individual retirement account is exempt from taxation . . . unless such account has ceased to be an individual retirement account by reason of paragraph (2) or (3). Notwithstanding the preceding sentence, any such account is subject to the taxes imposed by Section 511 (relating to imposition of tax on unrelated business taxable income of charitable, etc., organizations). [Italics added].

To the extent that there is unrelated business taxable income (UBTI) earned by the IRA, it will be currently reportable and taxable by the retirement plan participant. The interest earned by the promissory note is expressly excluded from the definition of UBTI in IRC § 512(b)(1).
There shall be excluded [from the definition of unrelated business taxable income] all dividends, interest, payments with respect to securities loans (as defined in section 512(a)(5)), amounts received or accrued as consideration for entering into agreements to make loans, and annuities, and all deductions directly connected with such income.

See also, Treasury Regulation 1.512(b)-1(a)(1). As a result of the relationship between the parties and the character of the income generated, the IRA, through the LLC, is authorized under current federal tax law to extend secured financing to the Debtor without current income taxation as result of generating unrelated business taxable income.

### Exclusive Benefit Rule

The first sentence of IRC § 408(a) provides that the IRA is a trust created for the “exclusive benefit an individual or his beneficiaries.” The term “exclusive benefit” is not specifically defined in the section. This term is generally gleaned through administrative guidance and jurisprudence issued under IRC § 401(a) dealing with Qualified Plans and Employees.

Private Letter Ruling 9713002 provides an excellent review of pertinent ERISA and IRC statutes.
Section 404(a)(1)(B) of Title I of the ERISA provides that a fiduciary shall discharge his duties with respect to a plan solely in the interest of the participants and their beneficiaries and with the care, skill, prudence and diligence under the circumstances then prevailing that a prudent man acting in a like capacity and familiar with such matters would use in the conduct of an enterprise of a like character and with like aims. This is commonly referred to as the “prudent man rule”. Section 2550-404a-1(b) of the Department of Labor (“DOL”) Regulations states that ERISA section 404(a)(1)(B) is satisfied if the fiduciary has given “appropriate consideration” to the facts and circumstances relevant to an investment and the fiduciary has acted accordingly.

Under these regulations, “appropriate consideration” includes at least two elements. First, there must be a determination by the fiduciary that the particular investment or investment course of action is reasonably designed as part of a portfolio to further the purposes of the plan, taking into consideration the risk of loss and the opportunity for gain (or other return) associated with the investment or investment course of action. Second, there must be consideration of the following three factors as they relate to such portions of the portfolio: (1) the composition of the portfolio with regard to diversification; (2) the liquidity and current return of the portfolio relative to the anticipated cash flow requirements of the plan; and (3) the projected return of the portfolio relative to the funding objectives of the plan.

These elements are combined in Revenue Ruling 69-494. This ruling outlines the standard of review of whether there is a violation of the exclusive benefit rule through the introduction of a four-pronged analysis:
(1) the cost (of the investment) must not exceed fair market value at time of purchase;
(2) a fair return commensurate with the prevailing rate must be provided;
(3) sufficient liquidity must be maintained to permit distributions in accordance with the terms of the plan, and
(4) the safeguards and diversity that a prudent investor would adhere to must be present.

These prongs are discussed in further detail below. Especially in light of the strong collateralization, the Loan in the retirement plan is structured in a manner that likely satisfies the exclusive benefit rule.

(1) Not excessive cost

The IRA Owner or LLC bears little to no cost in purchasing the investment or implementing the loan. The loan is made and the lender bears no closing costs associated with the investment. The Charity pays costs related to closing the loan. The cost is equal to, or less than, fair market value at the time of purchase.

(2) Fair Return

The structure of the loan, including the collateral, is based upon the particular facts and circumstances of each plan owner, LLC and Charity. The principal of the note is secured by permanent death benefit. The interest is paid on a regular basis and is compounded on a regular basis.

The interest rate for the present retirement plan promissory note is generally comparable to short-term commercial bonds. Based on the cash flow requirements of the IRA Owner and LLC, the interest rate is not intended to be below market. The interest rate charged is, in most cases, in excess of those offered by Certificates of Deposit and money market funds.

(3) Liquidity to Meet Plan Distributions

Private Letter Ruling 9705004 provides the following analysis of the time period under consideration with respect to liquidity.
Regulation section 1.401-1(b)(2) states that the term “plan” implies a permanent as distinguished from a temporary program. Thus, although the employer may reserve the right to change or terminate the plan and to discontinue contributions, the abandonment of a plan for any reason other than business necessity within a few years after it has taken effect will be evidence that the plan from its inception was not a bona fide program for the exclusive benefit of employees in general. The permanency of such plan will be indicated by all of the surrounding facts and circumstances, including the likelihood of the employer's ability to continue contributions as provided under the plan.

Private Letter Ruling 9724001 also found a violation of the exclusive benefit rule where “the Loans resulted in almost a total lack of liquidity in the Plan so that benefits were not able to be paid when due.

This theme of having sufficient liquidity to meet plan benefits is repeated in other legal sources. In 29 CFR Section 404a-1 of ERISA in that the investment duties of the plan owner is to include an analysis of “the liquidity and current return of the portfolio relative to the anticipated cash flow requirements of the plan.”

The retirement plan does not present the same liquidity needs as is required by an active employee benefit plan. The main requirement of the plan owner is the ability to satisfy their minimum required distributions. Technically, this distribution could be satisfied by an in-kind or cash distribution. The investment strategy of the retirement plan requires very little liquidity. Upon the death of the plan owner, the loan is paid off and the IRA has ample liquidity. The inherent potential for fraud where the Employer is making loans to him/herself is clear. This potential, however, is not present with the retirement plan as the loan is made to a third party.

(4) Prudent Investor

Stated in another way, this is a fiduciary or “prudent man” standard. In relevant part, 29 CFR Section 1104, ERISA sets forth this standard.
[A] fiduciary shall discharge his duties with respect to a plan solely in the interest of the participants and beneficiaries and—(A) for the exclusive purpose of: (i) providing benefits to participants and their beneficiaries; and (ii) defraying reasonable expenses of administering the plan; (B) with the care, skill, prudence, and diligence under the circumstances then prevailing that a prudent man acting in a like capacity and familiar with such matters would use in the conduct of an enterprise of a like character and with like aims; (C) by diversifying the investments of the plan so as to minimize the risk of large losses, unless under the circumstances it is clearly prudent not to do so.

In Department of Labor Advisory Opinion 98-04A, May 28, 1998, the Department considered socially motivated investments such as the RETIREMENT PLAN in the context of the fiduciary standards.
The Department has expressed the view that the fiduciary standards of sections 403 and 404 do not preclude consideration of collateral benefits, such as those offered by a “socially-responsible” fund, in a fiduciary's evaluation of a particular investment opportunity. However, the existence of such collateral benefits may be decisive only if the fiduciary determines that the investment offering the collateral benefits is expected to provide an investment return commensurate to alternative investments having similar risks . . . .

In discharging investment duties, it is the view of the Department that fiduciaries must, among other things, consider the role the particular investment or investment course of action in the plan's investment portfolio, taking into account such factors as diversification, liquidity, and risk/return characteristics. Because every investment necessarily causes a plan to forgo other investment opportunities, fiduciaries also must consider expected return on alternative investments with similar risks available to the plan.

In Winger's Department Store v. Commissioner, 82 T.C. 869 (1984), the Tax Court held that where a pension trust loaned a major portion of its assets to the employer through the employer's sole shareholder (a disqualified party), the loans were unsecured, interest was delinquent, and most of the principal remained outstanding, the trust did not operate for the exclusive benefit of the employees and was no longer qualified under section 401 (a) of the Code. The employer's sole shareholder and his wife were co-trustees of the plan, and most of the pension benefits under the plan accrued to the owner. The court noted that the purpose of the plan loans was to meet the employer's working capital needs, and that the terms of the plan were not followed. While the court did not rely specifically on the Internal Revenue Service's position, it based its conclusions on a similar analysis by carefully scrutinizing the underlying transactions and by finding a lack of diversity and safeguards, including the failure to seek loan repayments of principal and interest. The court held that, based on the totality of the facts, the loans violated the exclusive benefit rule of section 401 (a) of the Code as “the trust was operated effectively to service the needs of Winger and his wholly owned corporation” rather than for the exclusive benefit of employees and beneficiaries under the plan. Id. at 883. See also, Private Letter Ruling 9724001.

In Private Letter Ruling 9701001, the IRS held that a violation of the exclusive benefit rule where
. . . the loans cannot be regarded as prudent investments because they did not provide the Plan with the safeguards which a prudent investor would require for an investment. The loans, in most cases, were not evidenced by a note or any other writing; the loans were unsecured except by the Taxpayer's benefit/account balance and no objective consideration appears to have been given to the ability of the Taxpayer to repay the loans. Indeed, the Taxpayer has not been able to repay the loans.

In addition to Revenue Ruling 69-494, there are other sources of restrictions that warrant consideration. IRC §503 provides guidance with respect to the preservation of the tax exempt nature of a nonprofit organization in the event of a prohibited transaction. This Section would likely apply to the IRA through its reference to IRC §401. In order to preserve the tax exempt environment of the IRA for a given period, the Loan would have to be adequately secured and bear a reasonable rate of interest comparable to other investments. No mention is made with respect to timing of interest payments. Presumably, these could be accrued over a reasonable period. Though not applicable to the retirement plan, the self-dealing rules of IRC §4941 provide a similar standard upon which to judge an appropriate lending transaction. Finally, while also not applicable, the private inurement or excess benefit rules of IRC § 4958 would not reach the transactions contemplated by retirement plan.

The restrictions provided for under the exclusive benefit rule are most harsh where the benefit is for the Employer. In the retirement plan, the loan is made to an unrelated and detached third party. Revenue Ruling 79-122 provides excellent insight into the true line over which the taxpayer cannot cross without violating the exclusive benefit rule. The mere fact that the Charity may derive economic benefit or that the IRA Owner derives some philanthropic benefit is not conclusive in determining whether there is a violation of the exclusive benefit rule. Department of Labor Advisory Opinion 2000-10A, Jul. 27, 2000. Consistent examples of the exclusive benefit rule are provided in Revenue Rulings 79-122 and 71-391.

Considering the strong collateralization and competitive interest rate, the IRA Owner has discharged their investment duties in compliance with fiduciary or prudent investor standards. In absence of any personal benefit to the IRA Owner, other than philanthropic satisfaction, only a tortured interpretation of the “exclusive benefit” rule would result in a violation.

### Deemed Distribution by Gift

If the loan were considered to be a gift by the IRA Owner, there would be a deemed taxable distribution to the IRA Owner. Guidance of whether the loan should be considered a gift was set forth under similar facts in Estate of Meyer B. Berkman v. Commissioner, T.C. Memo 1979-46. In Berkman, the patriarch transferred property to children in exchange for promissory notes. The issue was focused upon whether the promissory notes were to be recognized as valid and an arm's length transfer for gift tax purposes. The Court, in holding against the Taxpayer, considered
While the petitioner contends that the transfers were arm's-length transactions, the evidence in the record simply does not support its position. Even though the decedent may have had a profit motive in making these transfers because the interest rate on the notes was higher than he was earning on his money otherwise, this factor alone does not mean that the transfers were made at arm's length. There are other factors here which must be considered. To begin with, the decedent was over 75 years old when he began making these transfers in exchange for notes due in 20 years. In addition, the decedent took no security on these notes. Moreover, the notes did not require any principal payments until maturity. Finally, the transferees, the decedent's daughter and son-in-law, were the natural objects of his bounty. In his will, the decedent directed that all his property be divided equally between his two daughters. As a result, Barbara Given was bequeathed one half of the notes on which she was a debtor. Taking all of these factors into account, we conclude that the petitioner has failed to meet its burden of proof that the transfers were at arm's length and free of donative intent. Rule 142(a), Tax Court Rules of Practice and Procedure.
Since these transfers were not at arm's length or free of donative intent, the parenthetical criteria of section 25.2512-8, Gift Tax Regs., have not been met. Consequently, the promissory notes cannot be considered adequate and full consideration under this section of the regulations. However, because the notes were valid, enforceable obligations that paid interest we believe they did constitute consideration to the extent of their fair market values. We, therefore, hold that the difference between the amount of each of the first four transfers and the fair market value of each promissory note given in exchange constitutes a taxable gift. See Estate of Reynolds v. Commissioner, 55 T.C. 172, 201 (1970); Blackburn v. Commissioner, 20 T.C. 204, 207 (1953).

In this factually similar case, the failure to obtain security and the timing of principal payments to occur upon the death of the donor as forgiveness resulted in the holding in favor of a taxable gift. The value of this gift, though, was subjective and based upon the rate of interest available in the marketplace, “date of maturity, lack of security, and the solvency of the debtor.” It is noteworthy in the retirement plan that there is no effective debt forgiveness planned through the estate plan of the IRA Owner as there was in Berkman. While this fact in addition to the presence of adequate security would likely preclude any taxable gift, a consideration of the valuation issues is merited.

The promissory notes in Berkman were interest only, twenty year balloon notes with no prepayment prior to maturity. The notes provided no security. From a valuation perspective, the notes were discounted by an amount of approximately fifteen percent. This discount was the value of the taxable gift. The Tax Court in Harwood v. Commissioner, 82 T.C. 239 (1984) provided that, in considering whether there has been a transfer without adequate and full consideration, the net value of the amount transferred should, in the case of corporate or other bonds, take into consideration, the soundness of the security, the interest yield as well as the date of maturity.

In the present retirement plan, the notes have substantial and, often excess, collateral in the form of mortgage, life insurance and other property. The debtor is solvent and there is no planned forgiveness of the note. The note is permanently secured by the life insurance proceeds. The note payment is certain, in full and in cash. The likelihood of discount and the resulting taxable gift and deemed taxable distribution from the IRA to the IRA Owner, is nominal.

### Insurable Interest

There is persuasive guidance indicating that there is sufficient insurable interest to sustain the issuance of the Policy contemplated by the retirement plan. For example in South Carolina and many states, the legal authority is provided by jurisprudence and statute.

In Benton & Rhodes, Inc. v. Boden, 310 S.C. 400, 403-04, 426 S.E.2d 823, 825-26 (Ct. App. 1993), the South Carolina Court of Appeals defined an insurable interest as follows:
It may be said, generally, that any one has an insurable interest in property who derives a benefit from its existence or would suffer loss from its destruction. An insurable interest in property is any right, benefit or advantage arising out of or dependent thereon, or any liability in respect thereof, or any relation to or concern therein of such a nature that it might be so affected by the contemplated peril as to directly indemnify the insured.
. . . The term ‘interest,’ as used in the phrase ‘insurable interest,’ is not limited to property or ownership in the subject matter of the insurance . . . . [A]n insurable interest in property may arise from some liability which insured incurs with relation thereto . . . . Such liability may arise by force of statute or by contract, or may be fixed by law from the obligations which insured assumes.
. . . Moreover, an insurable interest in property does not necessarily imply a property interest in, or a lien upon, or possession of, the subject matter of the insurance, and neither the title nor a beneficial interest is requisite to the existence of such an interest, it is sufficient that the insured is so situated with reference to the property that he would be liable to loss should it be injured or destroyed by the peril against which it is insured. For instance, although a person has no title, legal or equitable, in the property, and neither possession nor right to possession, yet he has an insurable interest therein if it is primarily charged in either law or equity with a debt or obligation for which he is secondarily liable.

The contractual relationship created between Charity, LLC and IRA Owner, as debtor-creditor, alone would suffice to sustain the insurable interest. The South Carolina legislature, however, through statute, provides clarity with respect to this issue. S.C. Code Ann. § 38-63-100 (2002) provides that:
Notwithstanding any other provision of law, a bona fide charity or nonprofit corporation which is in compliance with the “Solicitation of Charitable Funds Act” (Chapter 55 of Title 33) has an insurable interest in the life of an insured under a policy in which the charity or corporation is irrevocably named as a beneficiary provided that the application for insurance is signed by the insured. The Charity, in the retirement plan, is the owner and irrevocable beneficiary.

The IRA Owner will sign the Policy application as insured. The Charity should have no issue in sustaining the assertion of an insurable interest with respect to the IRA Owner.

### Quid Pro Quo

The present retirement plan envisions that the IRA Owner may make outright independent contributions of minimum required distributions to the Charity at some point in the future. These contributions will be unrestricted with disposition left entirely to the discretion of the Charity's board. The contributed amounts could be utilized to make interest, if not principal, payments on the Loan. In such a case, the funds will be transferred to the IRA from the Charity.

Initially, it may appear as though there is an issue with respect to the validity of the charitable income tax deduction because the taxpayer might be receiving consideration, or quid pro quo, in return for the charitable gift.

In IRC § 6115(b), the term “quid pro quo” is defined as
. . . a payment made partly as a contribution and partly in consideration for goods or services provided to the payor by the donee organization. A quid pro quo contribution does not include any payment made to an organization, organized exclusively for religious purposes, in return for which the taxpayer receives solely an intangible religious benefit that generally is not sold in a commercial transaction outside the donative context.

The determination of quid pro quo requires the determination of whether the contributor expects a substantial benefit in return for the contribution. United States v. American Bar Endowment, KTC 1986-228 (S.Ct. 1986). In American Bar Endowment, the United States Supreme Court considered the substantial benefit test in the context of the “dual payment” test:
[a] payment of money generally cannot constitute a charitable contribution if the contributor expects a substantial benefit in return. S. Rep. No. 1622, 83d Cong., 2d Sess., 196 (1954); Singer Co. v. United States, 196 Ct. Cl. 90, 449 F.2d 413 (1971). However, as the Claims Court recognized, a taxpayer may sometimes receive only a nominal benefit in return for his contribution. Where the size of the payment is clearly out of proportion to the benefit received, it would not serve the purposes of 170 to deny a deduction altogether. A taxpayer may therefore claim a deduction for the difference between a payment to a charitable organization and the market value of the benefit received in return, on the theory that the payment has the “dual character” of a purchase and a contribution. See, e.g., Rev. Rul. 67-246, 1967-2 Cum. Bull. 104 (price of ticket to charity ball deductible to extent it exceeds market value of admission); Rev. Rul. 68-432, 1968-2 Cum. Bull. 104, 105 (noting possibility that payment to charitable organization may have “dual character”).
In Rev. Rul. 67-246, supra, the IRS set up a two-part test for determining when part of a “dual payment” is deductible. First, the payment is deductible only if and to the extent it exceeds the market value of the benefit received. Second, the excess payment must be “made with the intention of making a gift.” 1967-2 Cum. Bull., at 105. The Tax Court has adopted this test, see Murphy v. Commissioner, 54 T.C. 249, 254 (1970); Arceneaux v. Commissioner, 36 TCM 1461, 1464 (1977).

The present retirement plan does not involve quid pro quo as there is no substantial benefit received in return for the contribution. In applying the “dual payment” test, the interest owed by the Charity to the LLC is a legally binding obligation payable regardless of any future contribution. The interest obligation is an asset of the LLC that predates the contribution. The market value of the benefit received by the LLC or the IRA Owner from the Charity is zero as the asset received existed in its entirety prior to the interest payment or the charitable contribution. The charitable contribution is a wholly independent event. The fact of the pre-existing debt makes the conclusion that the contribution was charitably motivated incontrovertible. From a pure objective review, the IRA Owner must have intended to make a gift, as the IRA Owner is not receiving anything more than what was otherwise legally due. While there may be philanthropic return or tax deferral advantages, these are not capable of valuation as the benefit may nominal at best. Thus, the retirement plan does not involve quid pro quo under the dual payment test. The charitable contribution envisioned by the plan is wholly appropriate.

Viewed in another perspective is whether the Charity is enriched by the donation. Allen v. Commissioner, KTC 1991-128 (9th Cir. 1991). The cash donation by the donor is wholly independent of the debt obligation. Thus, when viewed from a balance sheet perspective, the Charity is necessarily enriched by the donation in an amount equal to the donation. The IRA Owner has definitely given up value as a result of the gift.

In addition, the donation is not impermissibly earmarked to an individual. See Revenue Ruling 62-113 and Peace v. Commissioner, 43 TC 1 (1964), acq. 1965-2 C.B. 6. There is a clear understanding that the contribution becomes a part of the charity's general funds and is distributed as determined by the officers.

### Economic Substance Doctrine

Under the doctrine of substance over form, the courts may look through the form of a transaction to determine its substance in light of economic realities. As explained by the Supreme Court in Frank Lyon Co. v. United States, 435 U.S. 561, 573 (1978):

This Court, almost 50 years ago, observed that “taxation is not so much concerned with the refinements of title as it is with actual command over the property taxed—the actual benefit for which the tax is paid.” Corliss v. Bowers, 281U.S. 376, 378 (1930). In a number of cases, the Court has refused to permit the transfer of formal legal title to shift the incidence of taxation attributable to ownership of property where the transferor continues to retain significant control over the property transferred. E.g., Commissioner v. Sunnen, 333 U.S. 591 (1948); Helvering v. Clifford, 309U.S. 331 (1940). In applying this doctrine of substance over form, the Court has looked to the objective economic realities of a transaction rather than to the particular form the parties employed. The Court has never regarded the simple expedient of drawing up papers as controlling for tax purposes when the objective economic realities are to the contrary. In the field of taxation, administrators of the laws and the courts are concerned with substance and realities, and formal written documents are not rigidly binding. Nor is the parties' desire to achieve a particular tax result relevant.

See also, e.g., Commissioner v. Court Holding Co., 324U.S. 331, 334 (1945) (“to permit the true nature of a transaction to be disguised by mere formalisms, which exits solely to alter tax liabilities, would seriously impair the effective administration of the tax policies of Congress”); Gregory v. Helvering, 293U.S. 465, 469 (1935)(refusing to give effect to transactions that complied with formal requirements for nontaxable corporate reorganization; “the question for determination is whether what was done, apart from the tax motive, was the thing which the statute intended”).

In ACM Partnership v. Commissioner, 157 F.3d 251 (3^{rd} Cir. 1998), cert. den. 526U.S. 1017 (1999), it was noted that
[t]he inquiry into whether the taxpayer's transactions had sufficient economic substance to be respected for tax purposes turns on both the “objective economic substance of the transactions” and the “subjective business motivation” behind them. Casebeer v. Commissioner, 909 F.2d 1360, 1363 (9th Cir. 1990); accord Lerman, 939 F.2d at 53-54 (noting that sham transaction has been defined as a transaction that “has no business purpose or economic effect other than the creation of tax deductions” and holding that taxpayer was not entitled “to claim ‘losses’ when none in fact were sustained”). However, these distinct aspects of the economic sham inquiry do not constitute discrete prongs of a “rigid two-step analysis,” but rather represent related factors both of which inform the analysis of whether the transaction had sufficient substance, apart from its tax consequences, to be respected for tax purposes. Casebeer, 909 F.2d at 1363; accord James v. Commissioner, 899 F.2d 905, 908-09 (10th Cir. 1990); Rose v. Commissioner, 868 F.2d 851, 854 (6th Cir. 1989).

It is noteworthy that, in the present retirement plan, the LLC retains absolute no control over the loaned funds. The IRA Owner has no ability to affect the disposition of the board on the manner of consuming the loaned assets. As owner of the Policy, the Charity could consume cash surrender value for charitable purposes. The loan was adequately collateralized but the transfer conferred no equity return to the IRA or LLC in the form of death benefit. Any economic benefit related to the “bet to die” nature of the insurance accrues to the benefit of Charity and not the LLC or the IRA. The objective economic substance of the retirement plan mirrors the legal form.

The “subjective business motivation” of the IRA Owner is the preservation of capital and not a tax motivation. The IRA Owner is primarily concerned with portfolio diversification through the redirection of economic capital from Wall Street to Main Street. In addition, the IRA Owner does receive an intangible philanthropic benefit. The retirement plan does not generate tax credits or deductions. Viewed from a public policy perspective, the retirement plan does not reduce the eventual income tax due upon distribution of the IRA to the beneficiary. In reality, the loan preserves the wealth for both the family and, indirectly, the Internal Revenue Service, as upon the distribution the tax is based upon the gross value. Where the gross value has been preserved for the beneficiaries of the IRA, it has also been preserved for future tax collection.

### Security Issuance

Federal Securities Registration

Title 15 U.S.C. Chapter 2A, Section 77b (a)(1)(“the Securities Act of 1933”) provides the following definition of a security:
The term “security” means any note, stock, treasury stock, security future, bond, debenture, evidence of indebtedness, certificate of interest or participation in any profit-sharing agreement, collateral-trust certificate, preorganization certificate or subscription, transferable share, investment contract, voting-trust certificate, certificate of deposit for a security, fractional undivided interest in oil, gas, or other mineral rights, any put, call, straddle, option, or privilege on any security, certificate of deposit, or group or index of securities (including any interest therein or based on the value thereof, or any put, call, straddle, option, or privilege entered into on a national securities exchange relating to foreign currency, or, in general, any interest or instrument commonly known as a “security”, or any certificate of interest or participation in, temporary or interim certificate for, receipt for, guarantee of, or warrant or right to subscribe to or purchase, any of the foregoing.

Sec. 77c.(a)(4) of Chapter 2A provides for the following exemptions from securities registration:

Except as hereinafter expressly provided, the provisions of this subchapter shall not apply to any of the following classes of securities:
(4) Any security issued by a person organized and operated exclusively for religious, educational, benevolent, fraternal, charitable, or reformatory purposes and not for pecuniary profit, and no part of the net earnings of which inures to the benefit of any person, private stockholder, or individual; or any security of a fund that is excluded from the definition of an investment company under section 3(c)(10)(B) of the Investment Company Act of 1940 (15 U.S.C. 80a-3(c)(10)(B));
(11) Any security which is a part of an issue offered and sold only to persons resident within a single State or Territory, where the issuer of such security is a person resident and doing business within or, if a corporation, incorporated by and doing business within, such State or Territory.

Title 15 U.S.C. Chapter 2B, Section 78c (a)(10) (“the Securities Act of 1934”) provides the following definition of a security
The term “security” means any note, stock, treasury stock, security future, bond, debenture, certificate of interest or participation in any profit-sharing agreement or in any oil, gas, or other mineral royalty or lease, any collateral-trust certificate, preorganization certificate or subscription, transferable share, investment contract, voting-trust certificate, certificate of deposit for a security, any put, call, straddle, option, or privilege on any security, certificate of deposit, or group or index of securities (including any interest therein or based on the value thereof), or any put, call, straddle, option, or privilege entered into on a national securities exchange relating to foreign currency, or in general, any instrument commonly known as a “security”; or any certificate of interest or participation in, temporary or interim certificate for, receipt for, or warrant or right to subscribe to or purchase, any of the foregoing; but shall not include currency or any note, draft, bill of exchange, or banker's acceptance which has a maturity at the time of issuance of not exceeding nine months, exclusive of days of grace, or any renewal thereof the maturity of which is likewise limited.

Sec. 78c.(e) of Chapter 2B provides for the following exemptions from securities registration:
(1) Exemption Notwithstanding any other provision of this chapter, but subject to paragraph (2) of this subsection, a charitable organization, as defined in section 3(c)(10)(D) of the Investment Company Act of 1940 (15 U.S.C. 80a-3(c)(10)(D)), or any trustee, director, officer, employee, or volunteer of such a charitable organization acting within the scope of such person's employment or duties with such organization, shall not be deemed to be a “broker”, “dealer”, “municipal securities broker”, “municipal securities dealer”, “government securities broker”, or “government securities dealer” for purposes of this chapter solely because such organization or person buys, holds, sells, or trades in securities for its own account in its capacity as trustee or administrator of, or otherwise on behalf of or for the account of—(A)such a charitable organization; (B)a fund that is excluded from the definition of an investment company under section 3(c)(10)(B) of the Investment Company Act of 1940 (15 U.S.C. 80a-3(c)(10)(B)); or (C) a trust or other donative instrument described in section 3(c)(10)(B) of the Investment Company Act of 1940 (15 U.S.C. 80a-3(c)(10)(B)), or the settlors (or potential settlors) or beneficiaries of any such trust or other instrument.
(2) Limitation on compensation The exemption provided under paragraph (1) shall not be available to any charitable organization, or any trustee, director, officer, employee, or volunteer of such a charitable organization, unless each person who, on or after 90 days after Dec. 8, 1995, solicits donations on behalf of such charitable organization from any donor to a fund that is excluded from the definition of an investment company under section 3(c)(10)(B) of the Investment Company Act of 1940 (15 U.S.C. 80a-3(c)(10)(B)), is either a volunteer or is engaged in the overall fund raising activities of a charitable organization and receives no commission or other special compensation based on the number or the value of donations collected for the fund.

Title 15 U.S.C. 80a-3(c)(10)(D) provides that “[n]otwithstanding subsection (a) of this section, none of the following persons is an investment company within the meaning of this subchapter:
(D) For purposes of this paragraph—(i) a trust or fund is “maintained” by a charitable organization if the organization serves as a trustee or administrator of the trust or fund or has the power to remove the trustees or administrators of the trust or fund and to designate new trustees or administrators; (ii) the term “pooled income fund” has the same meaning as in section 642(c)(5) of title 26; (iii) the term “charitable organization” means an organization described in paragraphs (1) through (5) of section 170(c) or section 501 (c)(3) of title 26; (iv) the term “charitable lead trust” means a trust described in section 170(f)(2)(B), 2055(e)(2)(B), or 2522(c)(2)(B) of title 26; (v) the term “charitable remainder trust” means a charitable remainder annuity trust or a charitable remainder unitrust, as those terms are defined in section 664(d) of title 26; and (vi)the term “charitable gift annuity” means an annuity issued by a charitable organization that is described in section 501 (m) (5) of title 26.

The exemptions provided preclude the charity under the Securities Act of 1933 and 1934 from the necessity of securities registration under Federal law. In a manner similar to federal law, the laws of most states expressly exempts charities from the necessity of securities registration related to the demand note issued by the charity.

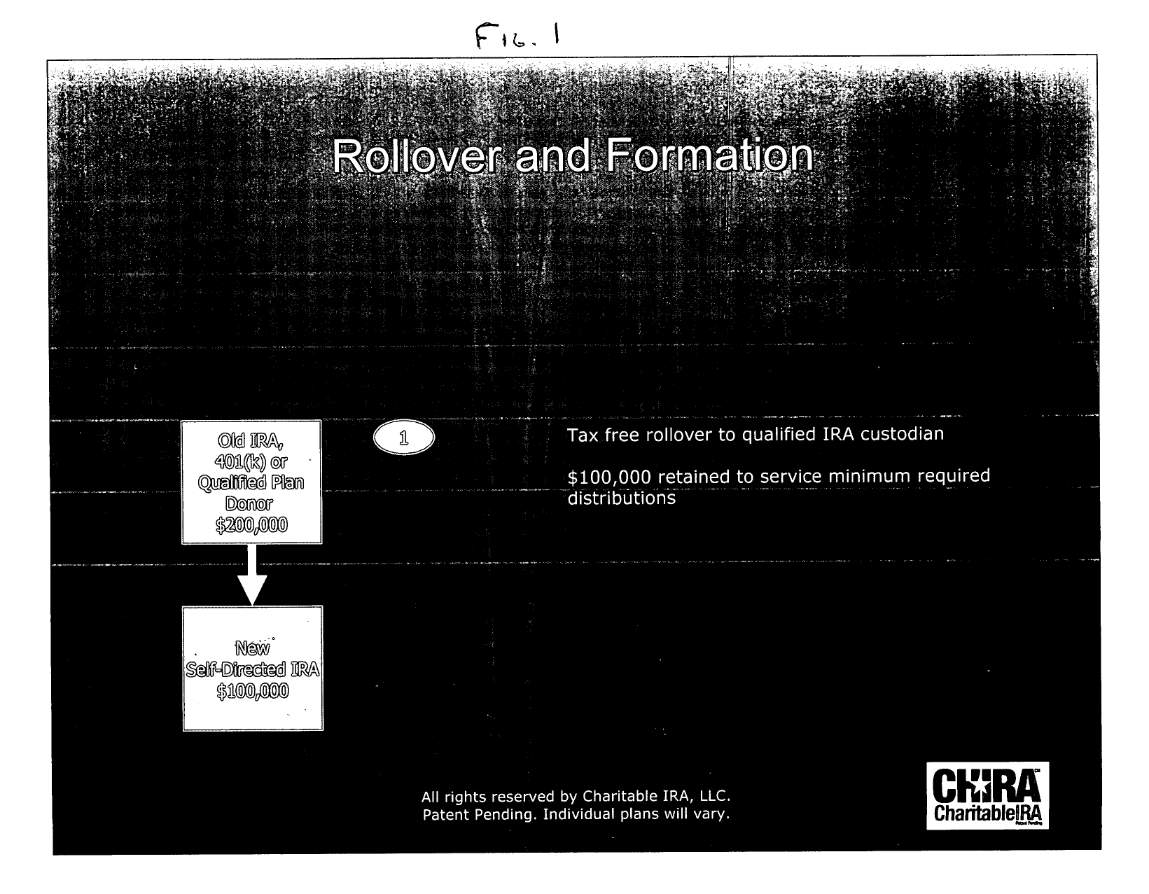

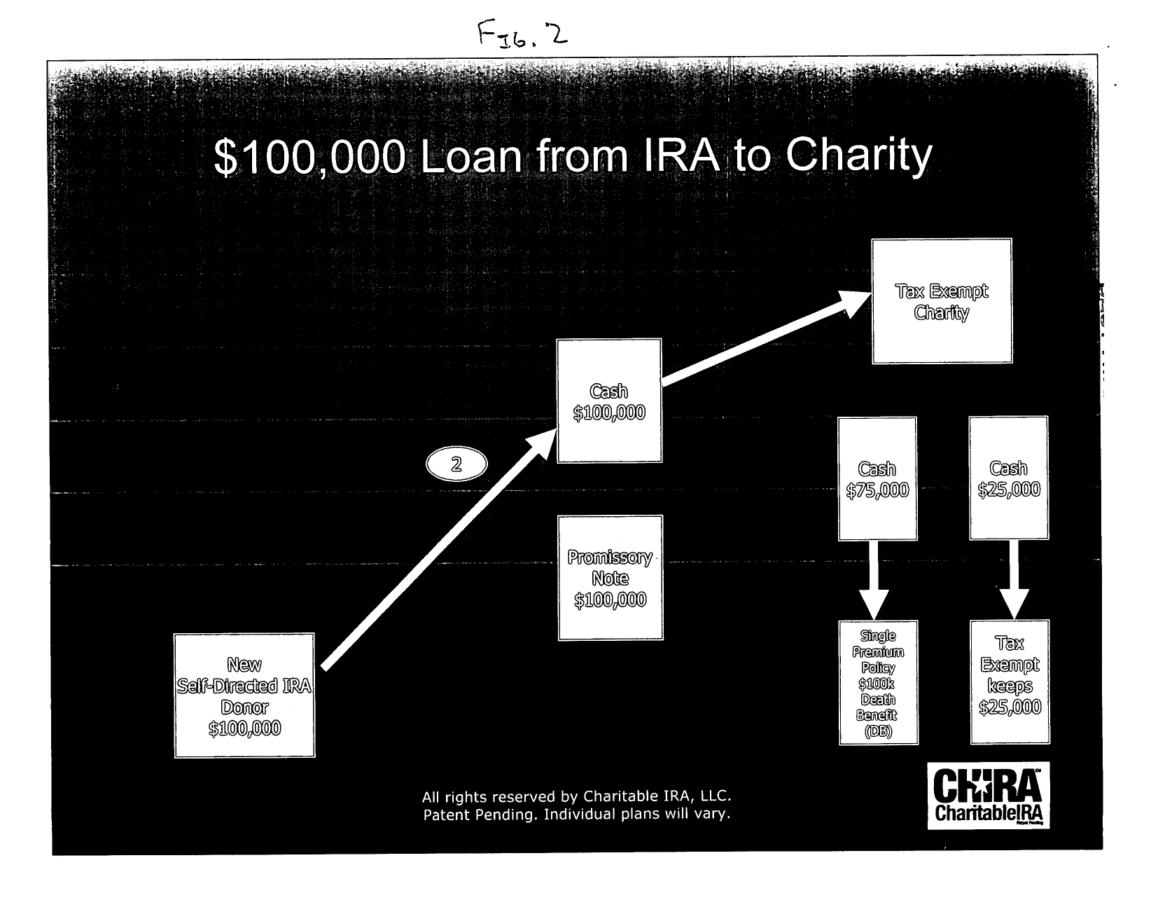

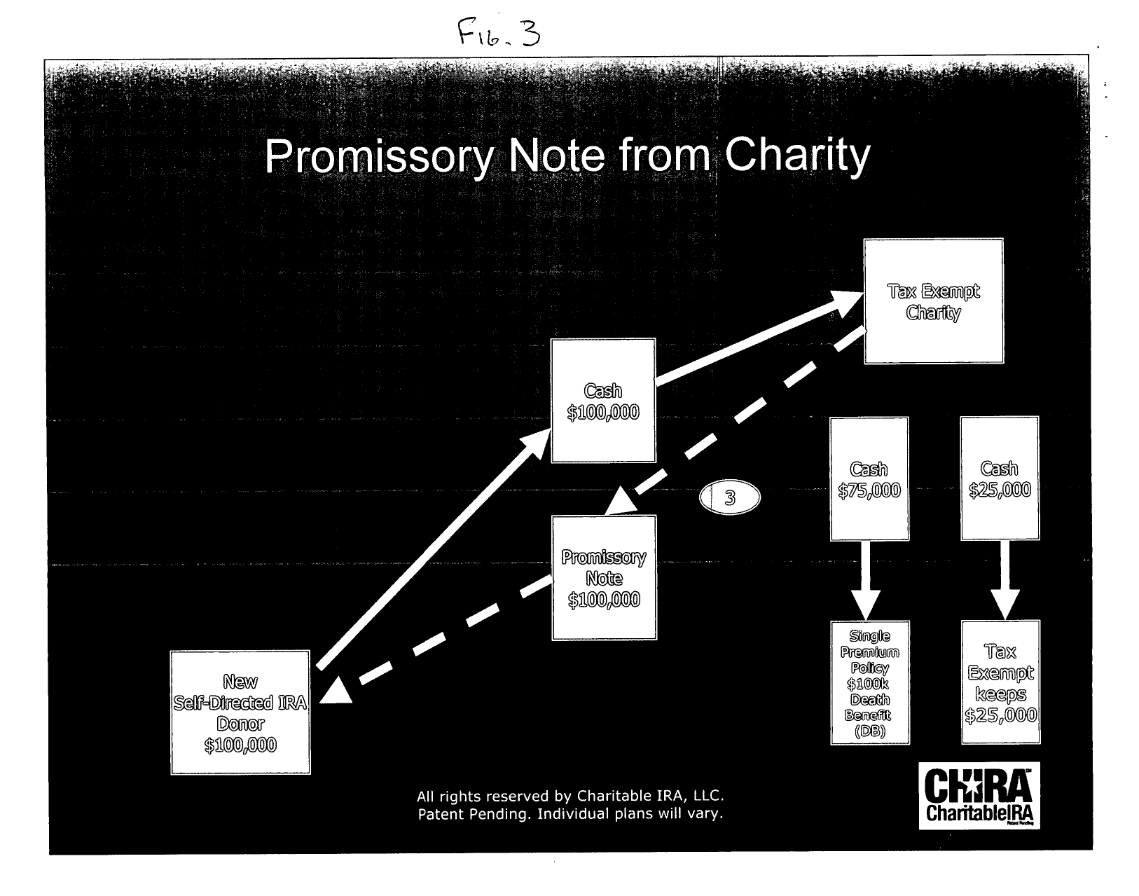

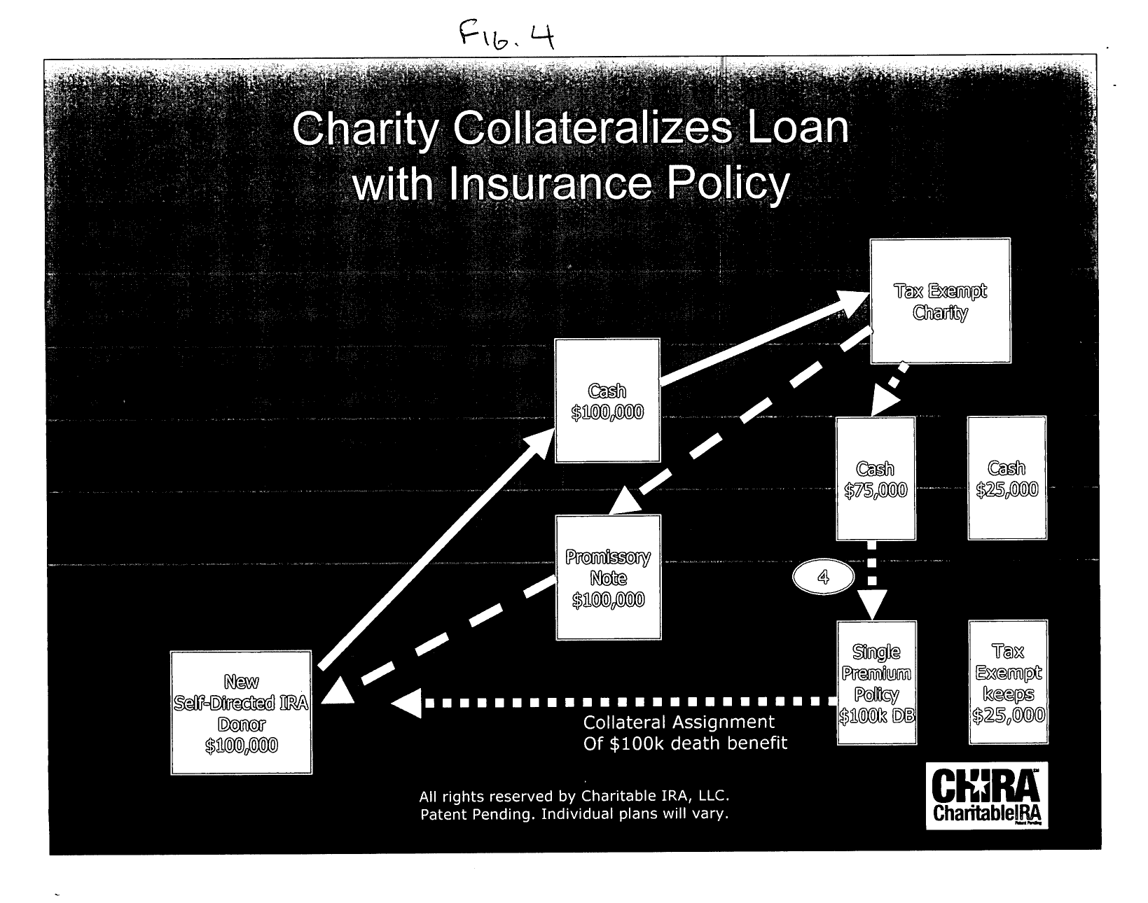

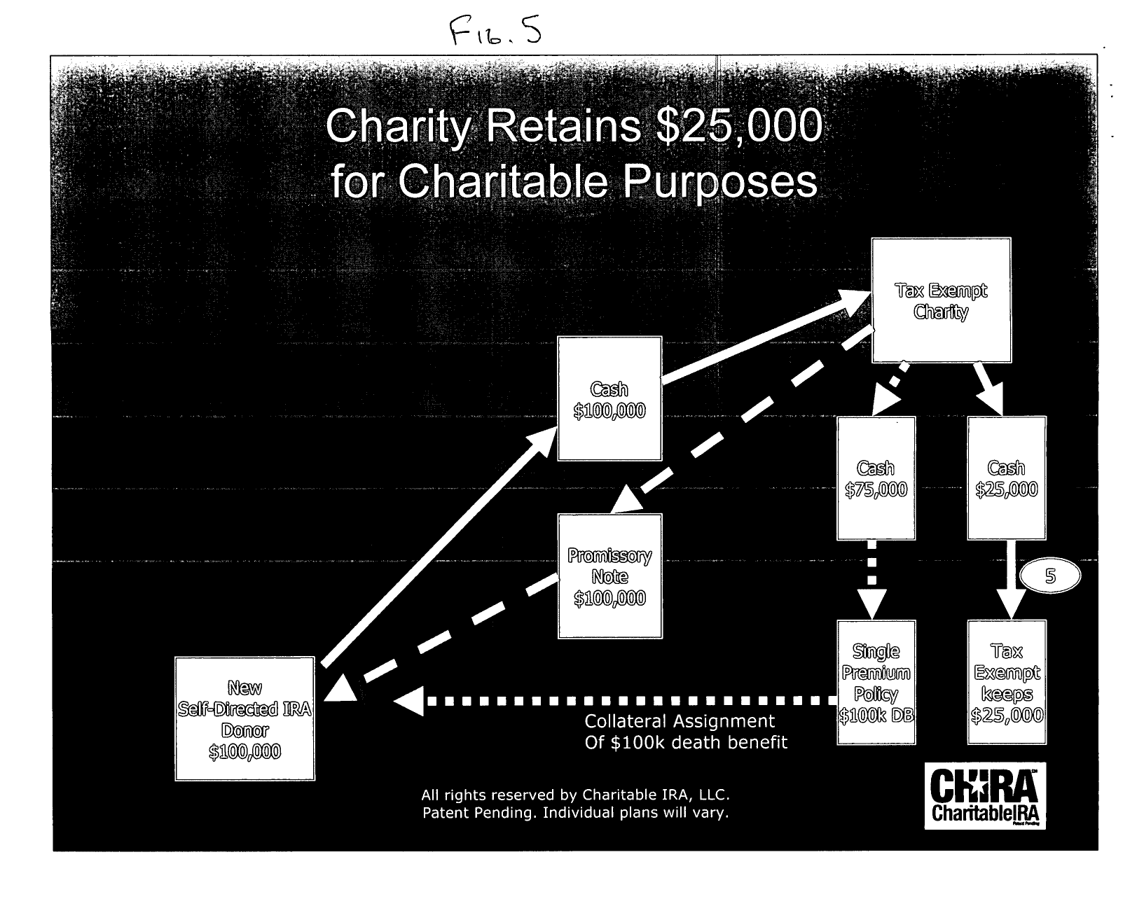

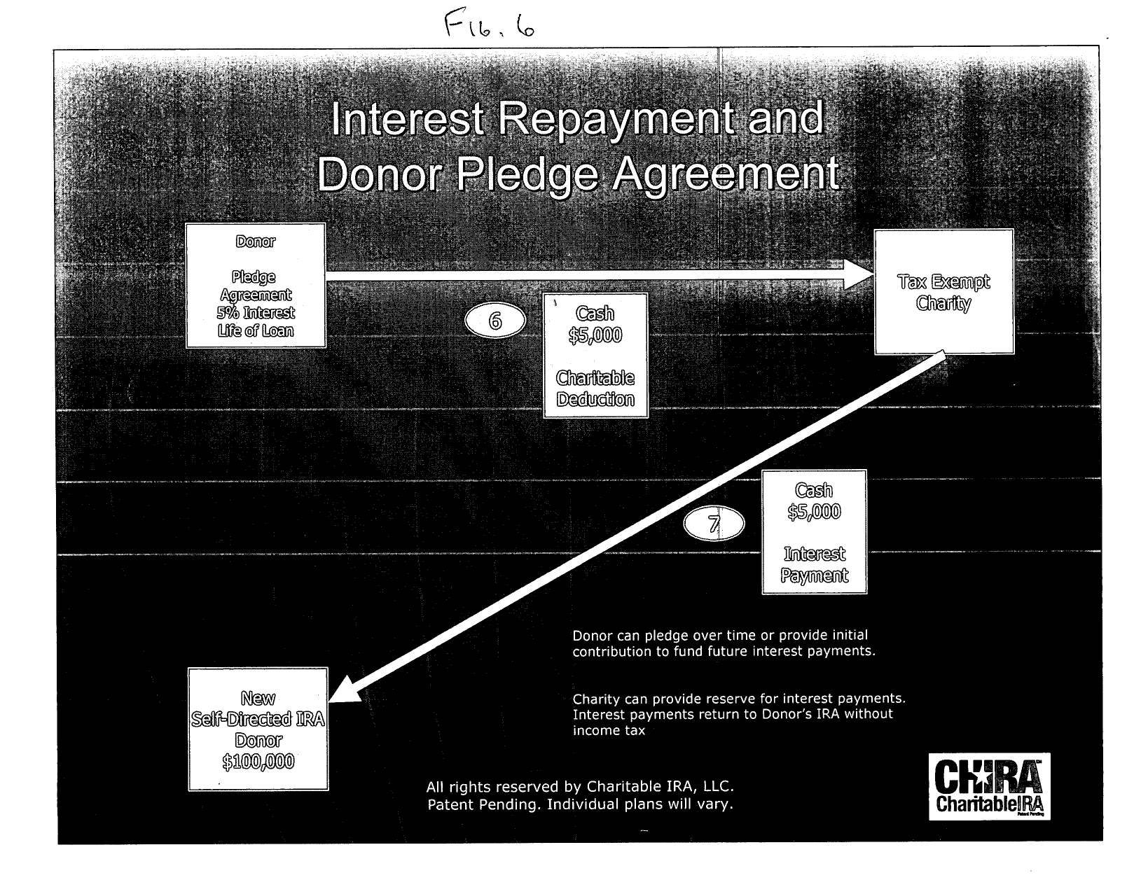

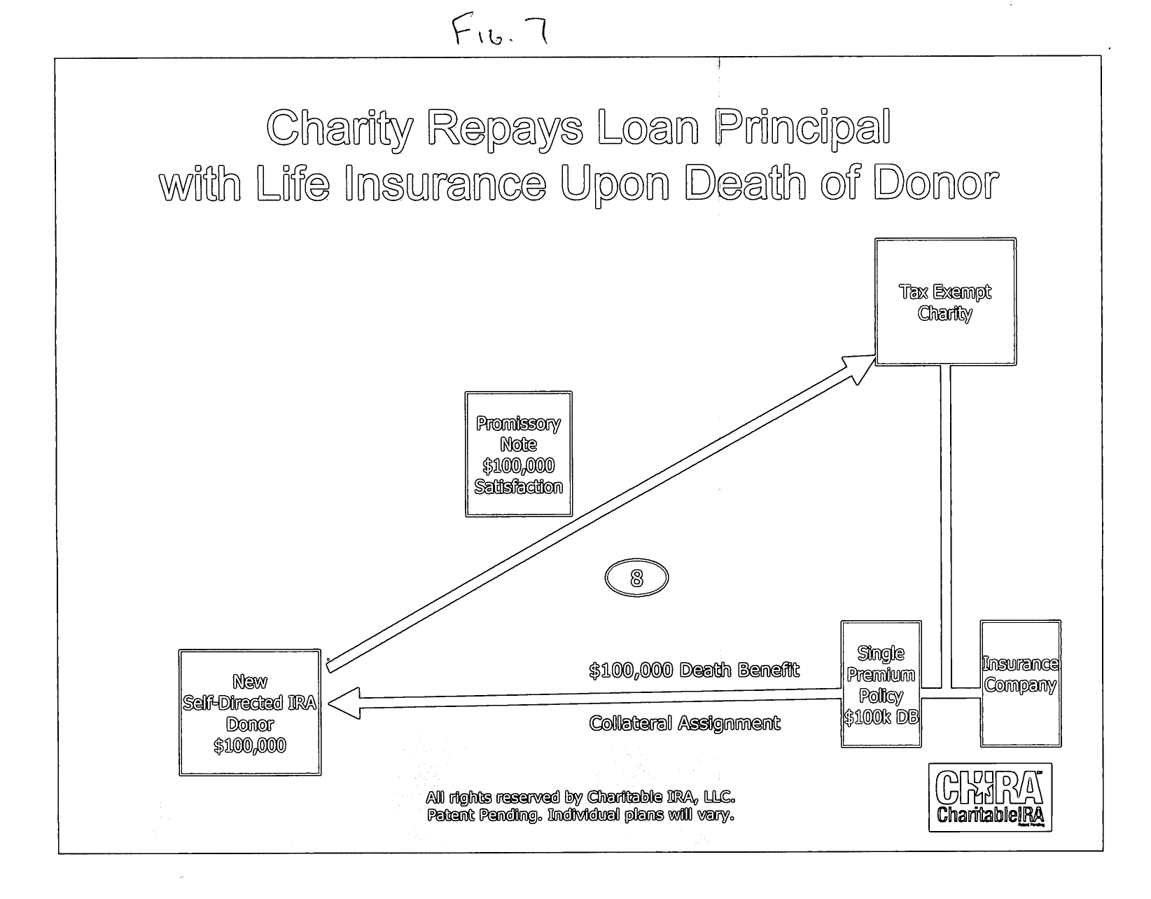

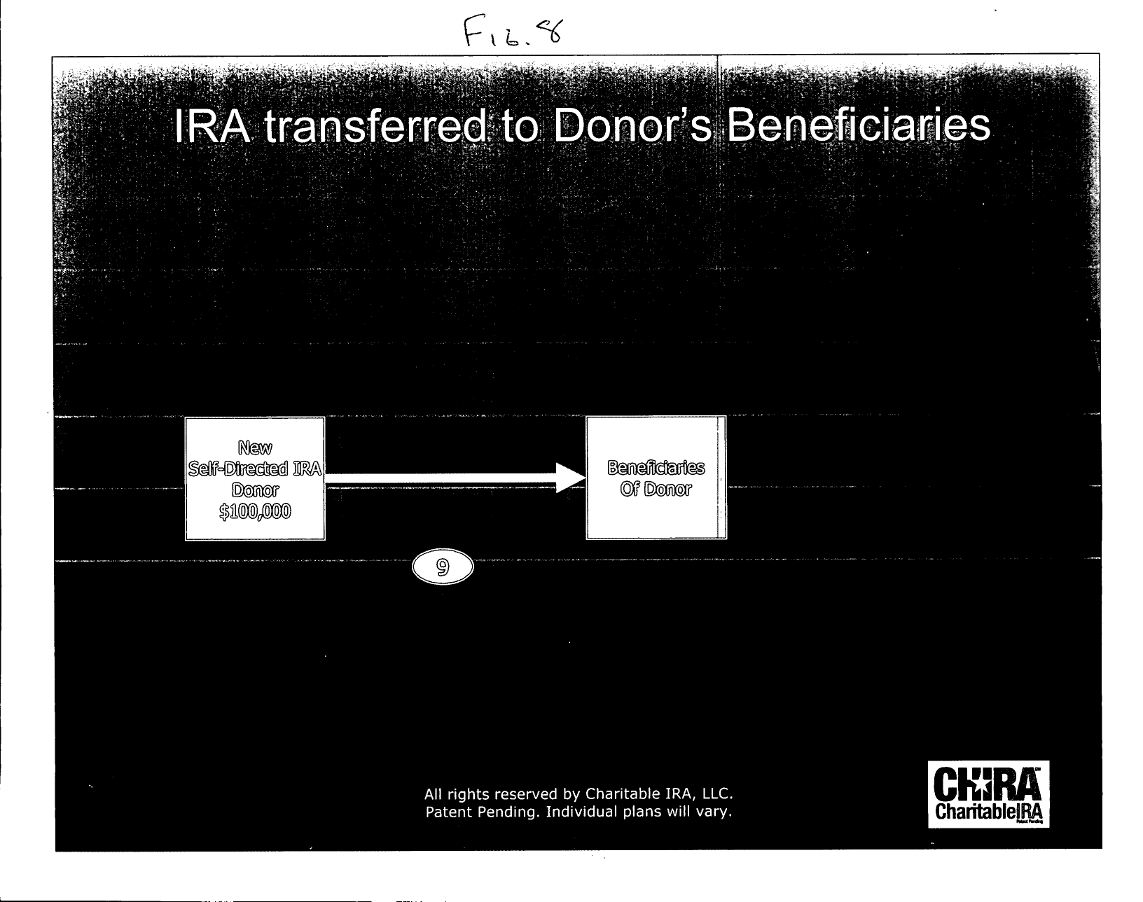

In accordance with an alternate embodiment of the present invention, and with reference to FIGS. 1 to 8, the step of directing funds to a wholly owned limited liability company as described above may be skipped and the method will be accomplished in the following manner:
A portion of an existing Individual Retirement Account Old Plan is transferred trustee to trustee to a newly formed self-directed plan (the plan itself, through its custodian is referred to herein as “New IRA” and the taxpayer as the “IRA Owner” or donor). The IRA Owner will retain sufficient funds in the Old Plan necessary to satisfy minimum required distributions as well as provide an overall diversified portfolio of investments.
A significant portion, if not all of the funds in the New IRA are loaned (“Loan”) to a tax-exempt organization (“Charity”). The Loan is a long term promissory note accelerated upon the death of the donor. The Loan could be an interest only balloon note with no pre-payment penalty. The Loan bears fair market interest. Annual payments are made by the Charity to the New IRA custodian.
As a condition of the Loan, the Charity utilizes a portion of the loaned funds to purchase a life insurance policy on the donor (Policy) this could be a single premium, permanent, guaranteed life insurance policy. The death benefits on the Policy are collaterally assigned to the New IRA to the extent of any outstanding debt on the Loan. The Charity is the owner and irrevocable beneficiary of the Policy. The IRA Owner signs the Policy application as insured. The Charity, in their board's discretion, utilizes the balance of the Loan funds (in excess of the insurance premium) for their charitable purposes. The IRA Owner, if a board member of the Charity, is precluded from any decision-making or voting on behalf of the Charity with respect to any matter concerning the Loan or the Policy.
The IRA Owner will, contemporaneously with the execution of the Loan, typically agree to donate funds to the Charity pursuant to a separately executed pledge agreement (Pledge Agreement). The Loan is an independent, legally binding agreement between creditor (New IRA) and debtor (Charity). The Pledge Agreement is an independent, legally binding agreement between donor (IRA Owner) and recipient (Charity). The Pledge Agreement provides that the funds may be used for any legal charitable purpose as determined by the Board of the Charity. The pledged amount will typically be, at minimum, that amount equal to satisfy annual interest payments on the Loan.
As a result of the Loan, and after purchase of the Policy and execution of the Pledge Agreement, the Charity will have use of remaining funds for their charitable purposes from a source of otherwise un-harvestable immediate donative capital. While the percentage of funds available for immediate charitable use will vary depending upon age and health of the IRA Owner, (as the insurance premiums will vary), the percentage will often be in excess of fifty (50%) percent. The Charity will have a secured source to repay both the interest and principal of the Loan. The secured nature of this Loan will not be subject to the passing whims of a changing board composition to access cash surrender value. The IRA Owner (as well as the income tax base represented the value of the New IRA) bears fair market interest and is fully collateralized. In a manner consistent with their fiduciary duty, the board members of the Charity will be able to access significant and immediate funds for their charitable needs. The structure of this relationship will protect both donor and Charity alike, without undermining the tax base.
Upon the death of the IRA Owner, the Charity is the owner and beneficiary of all of the insurance policy. The insurance net proceeds will be paid to the Charity subject to that amount collaterally assigned to the New IRA necessary to satisfy the outstanding Loan. The beneficiaries of the IRA Owner will be subject to taxation as otherwise provided by the tax laws.

As discussed above, substantially authority exists for the provision of the concepts underlying the present retirement plan. Since the legal analysis relating to the alternate embodiment differs slightly from that presented above due to the nature of the IRA owner making the loan directly to the Charity, those characteristic which differ between the embodiments are addressed below.

### Prohibited Transactions

The basic tenets relating to prohibited transactions are discussed above in relation to the prior embodiment and the role of the IRA Owner in the present retirement plan does not involve any of the prohibited transactions set forth above. A violation will not occur merely because the fiduciary derives some incidental benefit from a transaction involving IRA assets. DOL Advisory Opinion 2000-10A, Jul. 27, 2001. The IRA Owner, individually, does not receive any “consideration” for their own personal account as a result of the plan. This conclusion is supported by the DOL Advisory Opinions 2001-09A (Dec. 14, 2001) and 92-08A (Feb. 20, 1992).

Even under the most liberal reading of the relevant statutes provided in the IRC or ERISA, the Charity, at no time (provided the IRA Owner is not involved in any decisions concerning the Loan or Policy on behalf of the Charity) is considered a Disqualified Person or Party in Interest with respect to the IRA. The present retirement plan does not involve a prohibited transaction, as that term is set forth under applicable law.

### Prohibited Pledging of Assets

As discussed above with regard to the prior embodiment, IRC § Section 408(e)(4) provides If, during any taxable year of the individual for whose benefit an individual retirement account is established, that individual uses the account or any portion thereof as security for a loan, the portion so used is treated as distributed to that individual.

In the present retirement plan, the IRA Owner is in the private lending business. These are local debt related investments. The investments generate interest income from independent, non-Disqualified Persons. The Loan is bears fair market interest and is fully secured. The loaned funds are not utilized in a manner that benefits the IRA Owner, personally, other than philanthropic satisfaction. The present retirement plan does not involve a prohibited pledging of assets for the benefit of the IRA Owner. The funds transacted are merely another investment of the IRA.

### Prohibited Investment in Insurance

The laws concerning the allowable investments for an IRA are generally discussed above with regard to the other embodiment of the present plan.

As applied to the present embodiment, the prohibition of insurance ownership would only be triggered if the Charity's ownership of the Policy could somehow be attributed to the New IRA or the IRA Owner. First, the Charity has no outstanding equity ownership or issued shares of stock. Second, neither the New IRA nor IRA Owner has title to any equity ownership in the Charity. Third, the IRA Owner is expressly precluded from making any decisions or submitting any vote on behalf of the Charity with respect to either the Loan or the Policy. Fourth, neither the New IRA nor the IRA Owner possess any ownership interest in the Policy. Sixth, neither the New IRA nor the IRA Owner possess any rights to borrow, surrender or otherwise benefit from the cash surrender value of the Policy other than to prevent Charity from jeopardizing their collateral interest (i.e., by the Charity's borrowing of cash surrender value). The Charity's ownership of the policy cannot be attributed, directly or indirectly, to the New IRA or the IRA Owner. Therefore, the prohibition of insurance ownership is not applicable.

### Exclusive Benefit Rule

The first sentence of IRC § 408(a) provides that the IRA is a trust created for the “exclusive benefit an individual or his beneficiaries” and it application to the present retirement plan is discussed above with reference to the prior embodiment.

### Deemed Distribution by Gift

If the loan were considered to be a gift by the IRA Owner, there would be a deemed taxable distribution to the IRA Owner. The implications of this factor and the lack of application to the present retirement plan are considered above with regard to the prior embodiment.

### Personal Benefit Contract

In February 1999, the Congress of the United States took clear action to remedy an egregious planning scheme referred to as “Charitable Split Dollar.” This action soundly and fairly disallowed a charitable deduction under I.R.C. 170 for those transfers wherein there was an expectation, whether formally or informally, that the charity would pay any premium on any personal benefit contract. I.R.C. Section 170(a)(10)(A). The term “personal benefit contract” is set forth in 170(a)(10)(B) as follows:
PERSONAL BENEFIT CONTRACT—For purposes of subparagraph (A), the term ‘personal benefit contract’ means, with respect to the transferor, any life insurance, annuity, or endowment contract if any direct or indirect beneficiary under such contract is the transferor, any member of transferor's family, or any other person (other than an organization described in subsection (c)) designated by the transferor.

A plain reading of statute of indicates that the Policy contemplated in the present retirement plan is not a ‘personal benefit contract.’ First, the IRA Owner, under the separate and independent Pledge Agreement, is making unrestricted donations to the Charity for purposes determined by independent board member vote. Second, the Loan is a separate and independent contract bearing fair market interest. Third, the beneficiary of the Policy is the Charity. The IRA Owner has no rights in the Policy during life. Any mortality return associated with death accrues entirely to the Charity. Fourth, the Charity is expressly excluded from inclusion as a prohibited “person” in the latter part of the definition. Certainly, the New IRA is entitled to a fair rate of return as agreed upon by the independent board members of the Charity. However, the New IRA does not benefit from any life insurance proceeds outside of securing the repayment of the Loan.

Further, the present retirement plan does not involve the characteristics involved with the Charitable Split Dollar planning. In IRS Notice 99-36, it is noteworthy that there is an absence of the common feature presented in the prohibited split dollar plans. That is,
common feature is that, over the life of the split-dollar agreement, the trust [family or IRA Owner] has access to a disproportionately high percentage of the cash surrender value and death benefit under the policy . . . .

The present retirement plan does not provide for any access to cash surrender value. Further, while the death benefit will collateralize the Loan, any excess death benefit accrues to the Charity. Finally, and most importantly, there is a real and substantial benefit to the Charity upon closing of the Loan. The Charity with the present retirement plan will truly benefit unlike with those implementing the Charitable Split Dollar planning.

As set forth in IRS Notice 99-36, generally, to be deductible as a charitable contribution under § 170 or 2522, a payment to charity must be a gift. A gift to charity is a payment of money or transfer of property without receipt of adequate consideration and with donative intent. See Rev. Rul. 67-246, 1967-2 C.B. 104, which holds that a payment to charity may be deductible, to the extent it exceeds the fair market value of the benefit received, if the excess is paid with donative intent; and § 1.170A-1(h) of the Income Tax Regulations. (See also U.S. v. American Bar Endowment, 477 U.S. 105 (1986), discussed in the Quid Pro Quo section).

In the present case, the Pledge Agreement is separate and independent from the Loan. The Loan is an arm's length lending relationship. The amount pledged whether or not equal to the interest due on the Loan is a legally enforceable obligation of the IRA Owner. It would certainly be a stretch of logic to state that the IRA Owner (in their non-fiduciary capacity as donor) is somehow receiving a “benefit” by self-funding their own interest payments, assuming the independent board members actually utilized the gifted funds to do so. There are numerous other investment opportunities that the IRA Owner could invest in to provide a similar secured investment. The Pledge Agreement is wholly motivated by charitable intent and therefore, any funds transferred pursuant thereto would be eligible for charitable deduction.

However, regardless of whether a taxpayer receives a benefit in return for a transfer to charity or has the requisite donative intent, §§ 170(f)(3) and 2522(c)(2) provide that generally no charitable deduction is allowed for a transfer to charity of less than the taxpayer's entire interest (i.e. a partial interest) in any property. Thus, no charitable contribution deduction is permitted when a taxpayer assigns a partial interest in an insurance policy to a charity. See Rev. Rul. 76-1, 1976-1, C.B. 57, which holds that a transfer to charity of an annuity contract constitutes a nondeductible gift of a partial interest where the transferor effectively retains the right under the annuity contract to purchase life insurance at reduced rates; and Rev. Rul. 76-143, 1976-1 C.B. 63, which holds that a transferor's irrevocable assignment of the cash surrender value of a life insurance policy to a charity, while retaining the right to designate the beneficiary and to assign the balance of the policy, is a transfer to charity of a nondeductible partial interest under § 170(f)(3).

In the present case, the donor is transferring the entirety of the donative cash, pursuant to the Pledge Agreement, to the Charity. The Charity's agreement to repay the Loan is separate and independent to the Pledge Agreement. One agreement's binding nature and performance does not affect the other. The Policy is wholly owned by the Charity. The IRA Owner never does posses any ownership or beneficiary rights in the Policy itself. Certainly, there is a collateral assignment back to the New IRA to secure the loan, but as indicated above in the Prohibited Investments in Insurance section, it would be a certain stretch of plain meaning to include a collateral assignment within the confines of an investment. The Charity owns the Policy. The IRA Owner owns the cash transferred. The Charity is obligated to repay the Loan pursuant to its terms. The Charity may or may not actually utilize the particular funds donated by the IRA Owner to repay the interest on the Loan. This decision is left to the independent board members and the management of the Charity. Notwithstanding, the interest is still due and owning to the New IRA.

### Quid Pro Quo

The present retirement plan envisions that the IRA Owner may make outright independent contributions to the Charity pursuant to the Pledge Agreement. These contributions will be unrestricted with disposition left entirely to the discretion of the Charity's independent board members. The contributed amounts could be utilized to make interest, if not principal, payments on the Loan. The contributed amounts could be utilized to make payments for regular and recurring expenses of the Charity, including utility or payroll expense. Regardless, the Loan interest is still due and owning.

Initially, it may appear as though there is an issue with respect to the validity of the charitable income tax deduction because the taxpayer might be receiving consideration, or quid pro quo, in return for the charitable gift. That is, does the fact that the contributed amounts might be used to repay interest under an independent loan agreement to the New IRA somehow arise to a personal benefit to the donor precluded by the tax laws? Does the donor, by contributing funds to a charity to enable the charity to service a separate and independent Loan agreement to the donor's IRA somehow arise to a benefit to the IRA Owner? Is the donor receiving something they were not otherwise legally entitled to? Although the answer to this question is clearly “No,” the legal analysis focuses upon the issue of Quid Pro Quo.

### Insurable Interest

As discussed above, there is persuasive guidance indicating that there is sufficient insurable interest to sustain the issuance of the Policy contemplated by the present retirement plan.

### Unrelated Business Taxable Income

To the extent that there is unrelated business taxable income (UBTI) earned by the IRA, it will be currently reportable and taxable by the plan participant. As discussed above, the interest earned by the promissory note is expressly excluded from the definition of UBTI in IRC § 512(b)(1).

### Economic Substance Doctrine

Under the doctrine of substance over form, the courts may look through the form of a transaction to determine its substance in light of economic realities. As explained above, the present retirement plan complies with the IRC.

The previous discussion presents an outline of the procedure involved in implementing the present retirement plan. With this in mind, the following scenario presents an example of a way in which the present retirement plan may be implemented. During the initial implementation period, the donor is contacted to participate in the present retirement plan. The agent implementing the plan and/or the charity may contact the donor. Upon contact, the donor agrees to participate in the present retirement plan and the charity initiates pre-approval of the insurance policy. The underwriting inquiry occurs and the insurance policy is pre-approved. Thereafter, the donor signs documents to create a new self-directed IRA and facilitate trustee-to-trustee transfer from the old IRA. The new self-directed IRA is funded and the charity signs a promissory note payable to the IRA custodian for the benefit of the donor. The IRA custodian thereafter receives the promissory note and provides the donor with a copy. The charity and the donor execute an insurance policy and collateral assignment referencing the promissory note. The IRA custodian then facilitates closing and transfers portions of the loan funds to pay premium directly to the insurance company. The IRA custodian then facilitates closing and transfers the balance of the loan funds to the charity. The charity receives the insurance policy as the owner and beneficiary, and the donor receives a copy of the insurance policy as a collateral assignee.

Thereafter, and on an annual and periodic basis, the IRA custodian notifies the charity, with a copy to the donor, of the annual interest payment obligations. The charity addresses this obligation with the owner by requesting a further gift. The donor gives cash to the charity to pay the interest (and, if applicable, the principal). The charity then pays the interest obligation to the IRA custodian. The charity may not transfer, borrow, surrender or otherwise affect the cash surrender value without participation of the donor through the IRA custodian. The charity may not affect ownership or beneficiary designation without participation of the donor through the IRA custodian. The donor further directs minimum required distributions from the old IRA or provides additional funds through the trustee-to-trustee transfer to the new IRA.

Upon the death of the donor, the donor's family or the charity provides a death certificate to the insurance company. The insurance company then requests from the IRA custodian and receives an amount subject to the collateral assignment (balance of promissory note and interest accrued). The insurance company then pays the donor, as collateral assignee, by submitting funds directly to the IRA custodian. The IRA custodian then provides promissory note satisfaction to the charity and the insurance company pays the balance of the death benefit to the charity.

At this point the charity contacts the beneficiary of the donor's IRA usually the donor's family to see if they wish to continue to participate in the present retirement plan. If they do, the beneficiary of the donor's IRA either maintains the IRA or facilitates spousal rollover. If the donor's family does not wish to participate in the present retirement plan, the beneficiary of the donor's IRA maintains the IRA, facilitates spousal rollover or directs a taxable distribution.

Through implementation of the present invention, the charitable IRA triggers no income tax, as there is no taxable distribution. The donor loans the IRA funds to the charity and the donor's loan is fully secured by the death benefit in the life insurance policy. As such, the charity owns and purchases the life insurance policy. The charity immediately receives a substantial amount of an unrestricted percentage of the loan proceeds for their charitable purpose.

In particular, the IRA owner filly secures the loan to the charity through the death benefit on a paid up life insurance policy; the IRA loan bears a market rate of interest as negotiated with the charity; and the charity receives an enormous, immediate benefit as a result of their ability to obtain an insurable interest in a pretax environment.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A method for implementing by a computer a charitable lending program through a retirement plan involving the use of a self directed account with a designated plan custodian, comprising the following steps:
loaning funds which originated from a self directed account of a donor to a tax-exempt organization;
creating a promissory note in the amount of the loaned funds payable to the plan custodian for the benefit of the donor;
using a portion of the loaned funds to purchase a life insurance policy on the donor, the balance of the loaned funds being available to the tax-exempt organization for use at their discretion;
calculating the loan payments of the tax-exempt organization; and
upon the death of the donor, the tax-exempt organization receives tax free the net death benefit proceeds from the life insurance policy after repayment of the loan.

2. The method of implementing charitable lending through a retirement plan according to claim 1, wherein prior to the step of loaning the funds a wholly-owned LLC is formed based upon funds from the self-directed plan having an account owner, wherein the account owner is assigned as Manager of the LLC, and the entirety of ownership of the LLC is titled for benefit of the account owner in the self-directed IRA with all distributions from the LLC directed to an institutional custodian of the self-directed plan, and wherein the step of loaning is achieved by loaning the funds from the LLC to a tax-exempt organization.

3. The method for implementing charitable lending through a retirement plan according to claim 2, wherein the funds in the LLC are loaned to a tax-exempt organization and are fully collateralized.

4. The method for implementing charitable lending through a retirement plan according to claim 2, wherein the tax-exempt organization is selected at the discretion of the Manager of the LLC.

5. The method for implementing charitable lending through a retirement plan according to claim 2, wherein neither the Manager nor the account owner is a board member or officer of the tax-exempt organization.

6. The method for implementing charitable lending through a retirement plan according to claim 1, further including transferring a preexisting IRA to create the self-directed plan.

7. The method for implementing charitable lending through a retirement plan according to claim 6, wherein the transfer of a preexisting IRA to the self-directed plan is achieved by a trustee to trustee transfer.

8. The method for implementing charitable lending through a retirement plan according to claim 1, wherein the tax-exempt organization is a charity.

9. The method for implementing charitable lending through a retirement plan according to claim 1, wherein the tax-exempt organization is a private foundation.

10. The method for implementing charitable lending through a retirement plan according to claim 1, wherein the tax-exempt organization is a public foundation.

11. The method for implementing charitable lending through a retirement plan according to claim 1, wherein the life insurance policy has a single premium for the term of the loan.

12. The method for implementing charitable lending through a retirement plan according to claim 1, wherein the death benefits proceeds provided by the life insurance policy serve collateral securing the loan.

13. The method for implementing charitable lending through a retirement plan according to claim 1, wherein the tax-exempt organization is the owner and irrevocable beneficiary of the life insurance policy.

14. The method for implementing charitable lending through a retirement plan according to claim 1, wherein the tax-exempt organization has an insurable interest in the donor and is the owner of the life insurance policy.

15. The method for implementing charitable lending through a retirement plan according to claim 1, wherein the donor signs an application for the life insurance policy application.

16. The method for implementing charitable lending through a retirement plan according to claim 1, wherein the tax-exempt organization has a governing body and, in the body's discretion, utilizes the balance of the loan funds in excess of premiums relating to the life insurance policy for charitable purposes.

17. The method for implementing charitable lending through a retirement plan according to claim 1, wherein the donor may independently donate funds to the tax-exempt organization during the lifetime of the donor.

18. The method for implementing charitable lending through a retirement plan according to claim 16, where the donated funds may be utilized to repay the loan.

19. The method for implementing charitable lending through a retirement plan according to claim 1, wherein upon the death of the donor the beneficiary of the self-directed plan is determined by the plan custodian.

20. The method for implementing charitable lending through a retirement plan according to claim 1, wherein taxation of distributions from the self-directed plan to the donor or beneficiaries is in accordance with the IRC.
